(19) United States
(12) Patent Application Publication
(10) Pub. No.: US 2019/0052717 A1
(43) Pub. Date: Feb. 14, 2019

(54) COMMUNICATION SYSTEM, EDGE SERVER, METHOD, AND STORAGE MEDIUM

(71) Applicant: NEC Corporation, Minato-ku, Tokyo (JP)

(72) Inventor: Takumi FUJIWARA, Tokyo (JP)

(73) Assignee: NEC Corporation, Minato-ku, Tokyo (JP)

(21) Appl. No.: 16/072,239

(22) PCT Filed: Feb. 9, 2017
(86) PCT No.: PCT/JP2017/004707

§ 371 Date: Jul. 24, 2018

(30) Foreign Application Priority Data
Feb. 18, 2016 (JP) 2016-028551

(51) Int. Cl. H04L 29/08; H04L 12/725

(52) U.S. Cl. CPC H04L 67/2814; H04L 67/2842; H04L 45/306; H04L 67/2809

(57) ABSTRACT

The present invention enables distribution of a message to a movable device, in publish/subscribe communications via a broker consisting of multiple stages. In an edge server, a message transmission and receiving unit receives, from a first broker, a message transmitted from a management device and directed to a device, or a message for which re-distribution was requested by another edge server and which is directed to the device. The message transmission and receiving unit transmits the received message to a second broker. When notified of a failure to distribute the message to the device, a request destination determination unit determines another edge server to serve as a re-distribution request destination. A re-distribution request unit transmits, to the first broker, the message directed to the device.

### TECHNICAL FIELD

The present invention relates to a communication technology based on a publish/subscribe model.

### BACKGROUND ART

A publish/subscribe model used when transmitting and receiving messages between apparatuses is known. In the publish/subscribe model, a subscriber registers a topic to be received in a broker. A publisher transmits, to the broker, a message including information indicating a topic. Then, the broker distributes the received message to a subscriber registering the topic indicated by information included in the message. Transmission of a message by a publisher through a broker is hereinafter also referred to as publishing. Further, reception of a message by a subscriber from a broker is also referred to as subscribing.

For example, PTL 1 describes an example of a technology using the publish/subscribe model. In the related art described in PTL 1, an application operating on a device with a small nonvolatile storage capacity repeats publishing output log data to a broker every time a size of the log data reaches a threshold value. Then, the broker transfers the log data to a subscriber registering a topic related to the log data. The subscriber subscribes to and analyzes the relevant log data.

Such a publish/subscribe model is often employed in an Internet of Things (IoT) field. The reason is that, since downsized and weight-reduced devices and sensors transmit data to a management apparatus in IoT, low-power and lightweight communication is required. Then, a publish/subscribe model is suited for low-power and lightweight communication. Protocols based on such a publish/subscribe model include one capable of setting a delivery guarantee level as a quality of service (QoS) of transmitted and received messages. Message Queue Telemetry Transport (MQTT) is a well known example. MQTT provides three stages of delivery guarantee levels: 0 (maximum once), 1 (minimum once), and 2 (precisely once).

When IoT is utilized in a large-scale system, there arises a situation that a large volume of sensors equipped on many devices exist. The sensors equipped on the devices are centrally managed by a management apparatus on a cloud. At this time, it is assumed that a publish/subscribe model is employed in communication between the management apparatus and the devices. In this case, a broker placed on the cloud alone provides limited processing performance of messages to and from many devices. Accordingly, edge servers and brokers that relay communication between the management apparatus on the cloud and the devices are placed in an intermediate layer. A broker in a cloud layer controls communication between the management apparatus and edge servers, and a broker in the intermediate layer controls communication between an edge server and devices. In other words, brokers are connected in multiple stages as a configuration in a publish/subscribe model in IoT.

PTL 2 describes an example of such a technology with a multistage broker configuration. The related art described in PTL 2 includes a tree structure with a multistage broker/provider configuration between a provider providing a service and a requester requesting a service. In order to receive a service provided by the provider, the requester transmits a request message to the broker. The broker transfers the received request message to another broker or provider connected in a subordinate position in the tree structure. Further, when another service needs to be called in processing responding to the received request message, the provider transmits the request message to another broker connected in a subordinate position.

### CITATION LIST

### Patent Literature

Patent Literature 1: Japanese Translation of PCT International Application Publication No. 2009-519509

Patent Literature 2: Japanese Unexamined Patent Application Publication No. 2006-72785

### SUMMARY OF INVENTION

### Technical Problem

In IoT as described above, there are many cases in which a device moves. Accordingly, in a system with a multistage broker configuration as described above, a broker in an intermediate layer communicable with a device may change with a move of the device. However, the aforementioned related arts have an issue of not being able to support a case in which a device moves.

The issue will be described in detail. When a communication system based on a publish/subscribe model has a multistage broker configuration, there is a problem that a delivery guarantee level from a management apparatus to a device is not guaranteed. Specifically, it is assumed that delivery guarantee levels are set in communications based on a publish/subscribe model respectively performed between the management apparatus and an edge server, and between an edge server and a device. In this case, even when each communication is processed based on a set delivery guarantee level, a level identical to the delivery guarantee level individually set in each communication is not guaranteed between the management apparatus and a device.

The problem will be described in more detail by use of a specific example. It is assumed that a management apparatus in a cloud layer manages a device through an edge server in an intermediate layer. An edge server in the intermediate layer is installed in each area in which a device may exist. Further, communication based on a publish/subscribe model is performed between the management apparatus and an edge server through a broker in the cloud layer. Further, communication based on a publish/subscribe model is performed between an edge server and a device through a broker in the intermediate layer provided in an area in which the edge server exists.

At this time, a case is considered in which the management apparatus transmits a message m1 in order to perform a management operation on a device A in an area A. The management apparatus publishes a message m1 specifying a topic for the device A to the broker in the cloud layer at a delivery guarantee level 1 (transmit minimum once). Next, an edge server in the area A in the intermediate layer subscribes to the message m1 related to the topic for the device A existing in the local area, from the broker in the cloud layer. At this time, the delivery guarantee level 1 is guaranteed between the management apparatus and the edge server in the area A.

Next, the edge server in the area A publishes the message m1 specifying the topic for the device A to a broker in the intermediate layer in the area A at the delivery guarantee level 1. However, it is assumed that the device A has moved from the area A to an area B at this point. In this case, the device A performs a subscription from a broker in the intermediate layer in the area B.

Accordingly, unless the device A returns to the area A from the area B, a subscription from the broker in the intermediate layer in the area A is not performed, and the message m1 is not distributed to the device A.

As described above, a state of “a message being lost,” that is, a message not being properly distributed occurs in spite of the management apparatus, the edge server, and the device individually operating normally, and the delivery guarantee level being set to 1 for a communication between one another.

Further, in this case, the broker in the intermediate layer in the area A saves the message m1 until distribution to the device A is completed by a subscription. As a reason for a subscription by the device A not being performed, a case such as the device A being powered off may be considered in addition to a move. Accordingly, a problem that pressure is put on a save area in the intermediate layer by the broker being required to save the undistributed message m1 until the distribution is completed or until a certain period elapses also occurs.

Further, it is assumed in the aforementioned case that the device A returns to the area A again. In this case, the initial message m1 from the management apparatus is distributed to the device A. However, there is a possibility that the device A has received a latest message m2 in another area from the management apparatus. In this case, a problem that an improper operation is caused by a latest setting being overwritten with a past setting by the past message m1 being distributed due to the return to the area A may occur.

Now, it is assumed that, in the related art described in PTL 1, communication based on a publish/subscribe model is performed between a device and an apparatus analyzing log data, by use of a multistage broker configuration. It is further assumed that there is a possibility that the device moves. However, the related art relates to transmission of log data from a mobile device to the analysis apparatus and is not able to address the aforementioned issue in a case of distributing a message to a mobile device.

Further, the related art described in PTL 2 assumes that a provider or a broker connected in a subordinate position to another broker is connected in a fixed manner. Accordingly, the related art is not able to address the aforementioned issue in a case of distributing a message to a mobile device.

The present invention has been made to solve the aforementioned issue. In other words, an object of the present invention is to provide a technology of more reliably distributing a message to a mobile device in a system performing communication based on a publish/subscribe model through a multistage broker configuration.

### Solution to Problem

An edge server according to the present invention to achieve the above object includes:

message transmission-reception means for
receiving, from a first broker connecting between a plurality of edge servers including an own edge server and a management apparatus by publish/subscribe communication, a message for a device to which distribution is handled by the own edge server, the message being transmitted by the management apparatus, or a message for a device to which redistribution is requested to the own edge server by another edge server and,
in order to distribute a received message to the device, transmitting the message to a second broker connecting between the own edge server and the device by publish/subscribe communication;

request destination determination means for, when a distribution failure of the message to the device is notified from the second broker, determining another edge server being a request destination for redistribution of the message to the device; and

redistribution request means for transmitting the message to the first broker in order to request redistribution of the message to the device to another edge server being the request destination.

Furthermore, a second broker according to the present invention is the second broker described above includes:

message distribution means for distributing the message received from the edge server to the device; and

distribution status management means for detecting a distribution failure of the message to the device and notifying the edge server of the failure.

Furthermore, a first broker according to the present invention is the first broker described above includes:

message distribution means for distributing, to the another edge server, the message of which the redistribution is requested to the another edge server by the edge server.

Furthermore, a communication system according to the present invention includes:

the edge server described above;

the second broker described above;

the first broker described above;

the management apparatus; and

the device.

Furthermore, a method according to the present invention includes:

receiving, from a first broker connecting between a plurality of edge servers including an own edge server and a management apparatus by publish/subscribe communication, a message for a device to which distribution is handled by the own edge server, the message being transmitted by the management apparatus, or a message for a device to which redistribution is requested to the own edge server by another edge server and,
in order to distribute a received message to the device, transmitting the message to a second broker connecting between the own edge server and the device by publish/subscribe communication;

when a distribution failure of the message to the device is notified from the second broker, determining another edge server being a request destination for redistribution of the message to the device; and

transmitting the message to the first broker in order to request redistribution of the message to the device to another edge server being the request destination.

Furthermore, a storage medium storing a program that causes a computer to execute:

a step of receiving, from a first broker connecting between a plurality of edge servers including an own edge server and a management apparatus by publish/subscribe communication, a message for a device to which distribution is handled by the own edge server, the message being transmitted by the management apparatus, or a message for a device to which redistribution is requested to the own edge server by another edge server and,
in order to distribute a received message to the device, transmitting the message to a second broker connecting between the own edge server and the device by publish/subscribe communication;

a step of, when a distribution failure of the message to the device is notified from the second broker, determining another edge server being a request destination for redistribution of the message to the device; and

a step of transmitting the message to the first broker in order to request redistribution of the message to the device to another edge server being the request destination.

### Advantageous Effects of Invention

The present invention is able to provide a technology of more reliably distributing a message to a mobile device in a system performing communication based on a publish/subscribe model through a multistage broker configuration.

### BRIEF DESCRIPTION OF DRAWINGS

FIG. 1 is a block diagram illustrating a configuration of a communication system according to a first example embodiment of the present invention.

FIG. 2 is a diagram illustrating an example of a hardware configuration of the communication system according to the first example embodiment of the present invention.

FIG. 3 is a diagram illustrating a functional block configuration of the communication system according to the first example embodiment of the present invention.

FIG. 4 is a flowchart illustrating an operation of the communication system according to the first example embodiment of the present invention.

FIG. 5 is a diagram illustrating a functional block configuration of a communication system according to a second example embodiment of the present invention.

FIG. 6 is a diagram illustrating an example of area map information according to the second example embodiment of the present invention.

FIG. 7 is a diagram illustrating an example of duplication control information according to the second example embodiment of the present invention.

FIG. 8 is a diagram illustrating an example of a message management table according to the second example embodiment of the present invention.

FIG. 9 is a diagram illustrating an example of a topic management table according to the second example embodiment of the present invention.

FIG. 10 is a diagram illustrating an example of a distribution status table according to the second example embodiment of the present invention.

FIG. 11 is a flowchart illustrating an outline of an operation of the communication system according to the second example embodiment of the present invention.

FIG. 12 is a flowchart illustrating an operation when a second broker detects a distribution failure, according to the second example embodiment of the present invention.

FIG. 13 is a flowchart illustrating an operation of an edge server determining a request destination for redistribution, according to the second example embodiment of the present invention.

FIG. 14 is a flowchart illustrating an operation of the edge server in a monitor mode, according to the second example embodiment of the present invention.

FIG. 15 is a flowchart illustrating an operation of the edge server making a request to a management apparatus for redistribution, according to the second example embodiment of the present invention.

FIG. 16 is a flowchart illustrating operations of the edge server and the second broker that are requested to perform redistribution, according to the second example embodiment of the present invention.

FIG. 17 is a schematic diagram illustrating an operation of a specific example according to the second example embodiment of the present invention.

FIG. 18 is a schematic diagram illustrating the operation of the specific example continued from FIG. 17.

FIG. 19 is a schematic diagram illustrating the operation of the specific example continued from FIG. 18.

FIG. 20 is a schematic diagram illustrating the operation of the specific example continued from FIG. 19.

FIG. 21 is a schematic diagram illustrating the operation of the specific example continued from FIG. 20.

FIG. 22 is a diagram illustrating a functional block configuration of a communication system according to a third example embodiment of the present invention.

FIG. 23 is a diagram illustrating an example of location information according to the third example embodiment of the present invention.

FIG. 24 is a diagram illustrating a functional block configuration of a communication system according to a fourth example embodiment of the present invention.

### EXAMPLE EMBODIMENT

Example embodiments of the present invention will be described in detail below with reference to drawings.

### First Example Embodiment

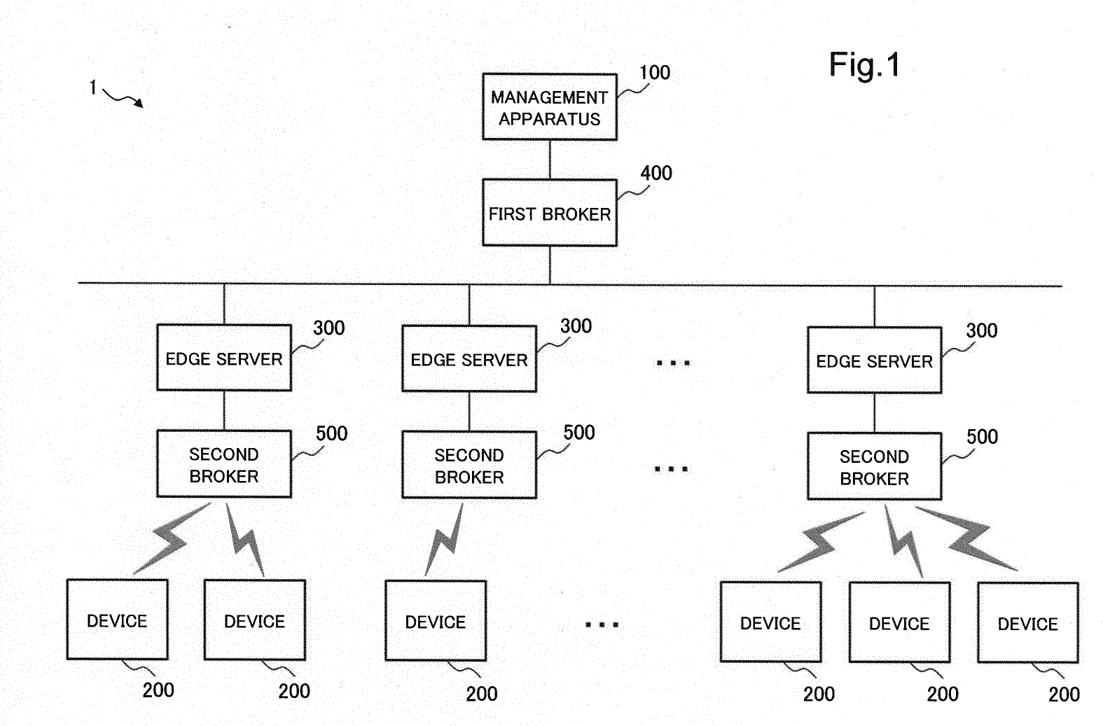

FIG. 1 illustrates a functional block configuration of a communication system 1 according to a first example embodiment of the present invention. In FIG. 1, the communication system 1 includes a management apparatus 100, a device 200, an edge server 300, a first broker 400, and a second broker 500. The management apparatus 100 and the first broker 400 are communicably connected through a network. Further, the first broker 400 and the edge server 300 are communicably connected through a network. Further, the edge server 300 and the second broker 500 are communicably connected through a network. Further, the second broker 500 and the device 200 are communicably connected through a network. The networks connecting the respective apparatuses include the Internet, a local area network (LAN), a public network, a wireless communication network, or a combination thereof. Since the device 200 is a mobile object, the network connecting the second broker 500 and the device 200 typically includes a wireless communication network. Accordingly, FIG. 1 illustrates an example of the second broker 500 and the device 200 being connected by a wireless communication network. However, the network connecting the second broker 500 and the device 200 is not limited to a wireless communication network.

The device 200 is a mobile object being a management target. Further, the management apparatus 100 is an apparatus managing one or more devices 200. Further, the edge server 300 is an apparatus relaying a communication between the management apparatus 100 and a device 200. A plurality of edge servers 300 are provided in the communication system 1. For example, for each area obtained by dividing a spatial range in which a device 200 is expected to move, the edge server 300 may be provided in such a way as to handle communication with a device 200 existing in the area. In that case, the number of edge servers 300 provided in one area may be one or more. The first broker 400 is an apparatus making connections between the management apparatus 100 and an edge server 300, and between a plurality of edge servers 300 by communication based on a publish/subscribe model. Communication based on a publish/subscribe model is hereinafter also referred to as publish/subscribe communication. The second broker 500 is an apparatus connecting an edge server 300 and a device 200 by publish/subscribe communication. For example, for each of the aforementioned areas, the second broker 500 may be provided in such a way as to connect a device 200 existing in the area and an edge server 300 handling the area.

While FIG. 1 illustrates one each of a management apparatus 100 and a first broker 400, the numbers of management apparatuses 100 and first brokers 400 in the communication system 1 are not limited. Further, while FIG. 1 illustrates three each of edge servers 300 and second brokers 500, the numbers of edge servers 300 and second brokers 500 in the communication system 1 are not limited. Further, while

FIG. 1 illustrates six devices 200, the number of devices 200 in the communication system 1 is not limited.

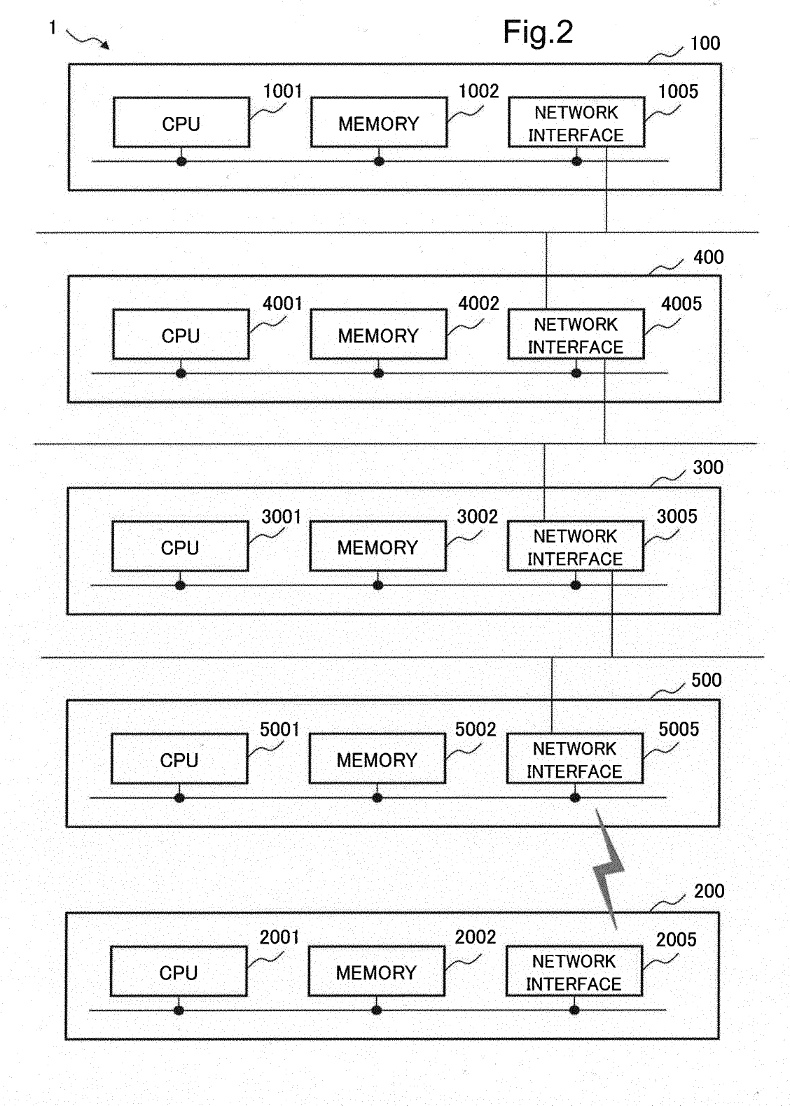

Each apparatus constituting the communication system 1 may be configured with hardware elements as illustrated in FIG. 2.

In FIG. 2, the management apparatus 100 includes a central processing unit (CPU) 1001, a memory 1002, and a network interface 1005. The memory 1002 is configured with a random access memory (RAM), a read only memory (ROM), an auxiliary storage apparatus (e.g. a hard disk and a flash memory), and the like. The network interface 1005 is an interface connected to a network communicable with the first broker 400. A function of the management apparatus 100 is provided by the CPU 1001 executing a computer program stored in the memory 1002 and also controlling the network interface 1005.

Further, the device 200 includes a CPU 2001, a memory 2002, and a network interface 2005. The memory 2002 is configured with a RAM, a ROM, an auxiliary storage apparatus, and the like. The network interface 2005 is an interface connected to a network communicable with the second broker 500. A function of the device 200 is provided by the CPU 2001 executing a computer program stored in the memory 2002 and also controlling the network interface 2005.

Further, the edge server 300 includes a CPU 3001, a memory 3002, and a network interface 3005. The memory 3002 is configured with a RAM, a ROM, an auxiliary storage apparatus, and the like. The network interface 3005 is composed of respective interfaces connected to networks communicable with the first broker 400 and the second broker 500, respectively. Each functional block, to be described later, in the edge server 300 is configured with the CPU 3001 executing a computer program stored in the memory 3002 and also controlling the network interface 3005.

Further, the first broker 400 includes a CPU 4001, a memory 4002, and a network interface 4005. The memory 4002 is configured with a RAM, a ROM, an auxiliary storage apparatus, and the like. The network interface 4005 is composed of respective interfaces connected to networks communicable with the management apparatus 100 and the edge server 300, respectively. Each functional block, to be described later, in the first broker 400 is configured with the CPU 4001 executing a computer program stored in the memory 4002 and also controlling the network interface 4005.

Further, the second broker 500 includes a CPU 5001, a memory 5002, and a network interface 5005. The memory 5002 is configured with a RAM, a ROM, an auxiliary storage apparatus, and the like. The network interface 5005 is composed of respective interfaces connected to networks communicable with the edge server 300 and the device 200, respectively. Each functional block, to be described later, in the second broker 500 is configured with the CPU 5001 executing a computer program stored in the memory 5002 and also controlling the network interface 5005.

The hardware configurations of each apparatus constituting the communication system 1 and each functional block in each apparatus are not limited to the aforementioned configurations.

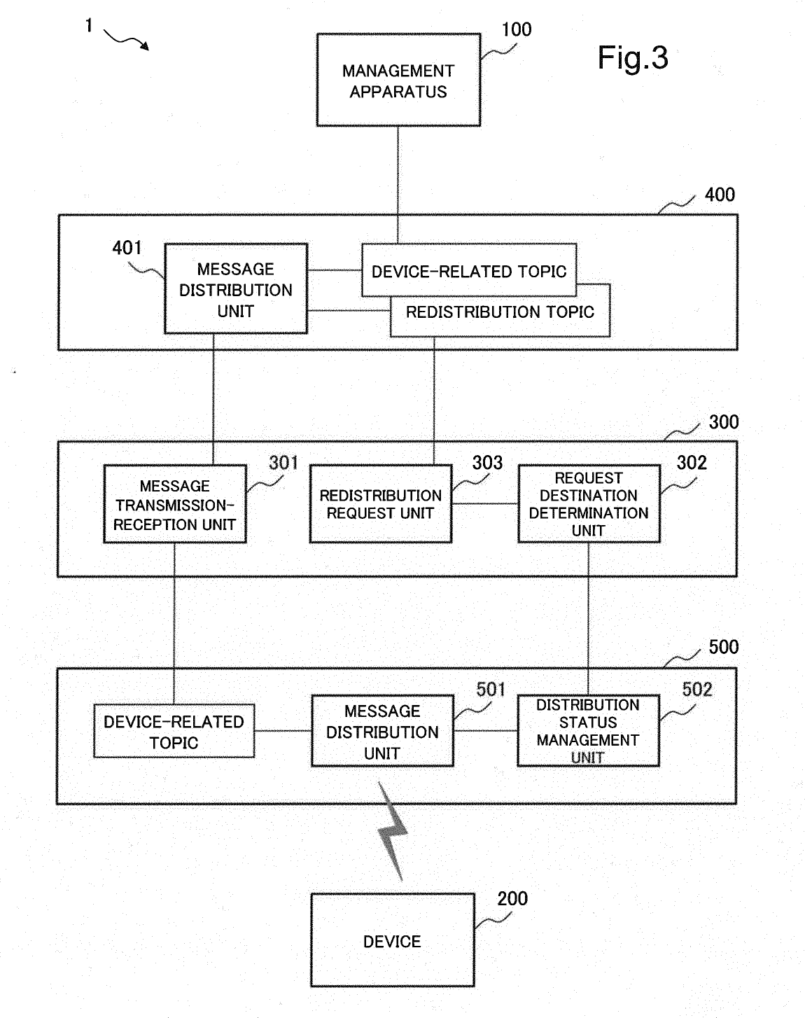

Next, a functional block configuration of each apparatus will be described in detail with reference to FIG. 3. In FIG. 3, as described above, the management apparatus 100 is an apparatus managing the mobile device 200. Further, the first broker 400 includes a message distribution unit 401. Further, the edge server 300 includes a message transmission-reception unit 301, a request destination determination unit 302, and a redistribution request unit 303. Further, the second broker 500 includes a message distribution unit 501 and a distribution status management unit 502. The device 200 is a mobile apparatus.

First, a function of the management apparatus 100 will be described.

The management apparatus 100 transmits a message for a device 200 to the first broker 400. Specifically, the management apparatus 100 may publish the message to a topic in the first broker 400. As the topic, for example, a topic related to the device 200 being a destination of the message is applied. Further, when an edge server 300 handling distribution to the device 200 being the destination is specifiable, a topic related to the device 200 being the destination and the edge server 300 handling the distribution is applied as the topic.

For example, a message includes information about control, management, or operation of a device 200. As a specific example, a message may include information about control of a direction, a zoom in, a zoom out, or the like with respect to a camera equipped on a device 200. Further, a message may include information for updating firmware on a device 200 or information for distributing an application installed on a device 200. Further, a message may include information for controlling a start or stop of a device 200. Further, a message may include information for setting a transmission interval of sensor information transmitted from a device 200. Further, a message may include information for a user carrying a device 200. However, information included in a message is not limited to the above.

Next, each functional block in the first broker 400 will be described.

When receiving a message for a device 200 from the management apparatus 100, the message distribution unit 401 distributes the message to an edge server 300 handling distribution to the device 200. Specifically, the message distribution unit 401 stores as a subscriber an edge server 300 handling distribution of a topic related to the device 200. The subscriber is an apparatus in which a subscription to the topic is registered. Then, when receiving the message, the message distribution unit 401 distributes the message to an edge server 300 stored as a subscriber to the topic.

Further, when receiving from an edge server 300 a message of which redistribution is requested to another edge server 300, the message distribution unit 401 distributes the message to the edge server 300 being a request destination. For example, a redistribution topic may be set to the first broker 400. The redistribution topic refers to a topic for transmitting and receiving various kinds of information accompanying a redistribution request between edge servers 300. The redistribution topic may be set for each combination of an edge server 300 on the transmit side of information, an edge server 300 on the receive side, and a device 200 being a redistribution destination. In that case, with respect to the redistribution topic, the message distribution unit 401 stores as a subscriber the edge server 300 on the receive side of the information. Then, when receiving a message to the redistribution topic from the transmit side, the message distribution unit 401 may distribute the message to the edge server 300 stored as the subscriber of the redistribution topic.

Next, each functional block in the edge server 300 will be described.

The message transmission-reception unit 301 receives from the first broker 400 a message for a device 200 from the management apparatus 100. A message being a reception target is a message for a device 200 to which distribution is handled by the edge server itself and a message for a device 200 to which redistribution is requested to the edge server itself by another edge server 300.

The message transmission-reception unit 301 registers in the first broker 400 a subscription to a topic related to a device 200 to which distribution is handled by the own edge server. In other words, by the registration, the edge server is stored in the first broker 400 as a subscriber to the topic related to the device 200 to which distribution is handled by the edge server itself.

For example, a device 200 to which distribution is handled by the edge server refers to a device 200 existing in an area distribution in which is handled by the edge server. For example, the edge server 300 may periodically detect a device 200 existing in an area handled by the own edge server, determine the detected device 200 as a device 200 to which distribution is handled by the own edge server, and register in the first broker 400 a subscription to a related topic. Specifically, the edge server 300 may periodically transmit information requesting registration through a wireless communication network in an area handled by the own edge server and determine a device 200 returning information responding to the request as a device 200 to which distribution is handled by the edge server itself. Alternatively, the second broker 500, to be described later, may perform such periodic detection. In that case, the message transmission-reception unit 301 may acquire information indicating a device 200 to which distribution is handled by the edge server itself by making an inquiry to the second broker 500.

Further, the message transmission-reception unit 301 transmits to the second broker 500 a message for a device 200 received from the first broker 400 in such a way that the message is distributed to the device 200. Specifically, the message transmission-reception unit 301 may publish the message received from the management apparatus 100 to a topic in the second broker 500. As the topic, for example, a topic related to the device 200 being a destination is applied.

When notified of a distribution failure of a message to a device 200 by the second broker 500, the request destination determination unit 302 determines another edge server 300 being a request destination for redistribution of the message to the device 200. Specifically, the request destination determination unit 302 may determine an edge server 300 being a request destination out of candidates of an edge server 300 being the request destination. For example, the request destination determination unit 302 may previously store information specifying edge servers 300 existing around the own edge server and determine the edge servers 300 as candidates.

Through the first broker 400, the redistribution request unit 303 requests to another edge server 300 determined by the request destination determination unit 302 redistribution of a message to a device 200 for which a distribution failure is notified. Specifically, the redistribution request unit 303 may publish the relevant message to the aforementioned redistribution topic.

Next, each functional block in the second broker 500 will be described.

When receiving a message for a device 200 from the edge server 300, the message distribution unit 501 distributes the message to the device 200. Specifically, when receiving a message for a topic, the message distribution unit 501 distributes the message to the device 200 stored as a subscriber to the topic.

The distribution status management unit 502 detects a distribution failure of a message for a device 200 and notifies the failure to the edge server 300. Specifically, when a message cannot be distributed due to communication with a device 200 stored as a subscriber to a topic receiving the message being impossible, the distribution status management unit 502 may first try retransmission of the message to the device 200. For example, the retransmission processing may be executed at predetermined intervals. Then, the distribution status management unit 502 may determine that distribution is unsuccessful, in accordance with a predetermined condition. For example, the predetermined condition may be a retransmission count reaching a threshold value or an elapsed time from the first distribution processing reaching a threshold value but is not limited thereto.

Next, a function of the device 200 will be described.

As described above, the device 200 is a mobile object being a management target. For example, the device 200 may be equipped on an object moving with a product being produced in a production line. Alternatively, for example, the device 200 may be an apparatus carried by a person. However, the above are examples and do not limit a mobile object applicable as the device 200. The device 200 receives a message from the management apparatus 100 by a publish/subscribe communication through the first broker 400, the edge server 300, and the second broker 500. Specifically, the device 200 registers a subscription to a topic related to the own device in a connected second broker 500. Consequently, as long as the device 200 is connected to the second broker 500, the device 200 receives a message published to the relevant topic in the second broker 500.

For example, a sensor may be equipped on the device 200. Then, the device 200 may register in the second broker 500 a subscription to a topic related to the sensor equipped on the own device.

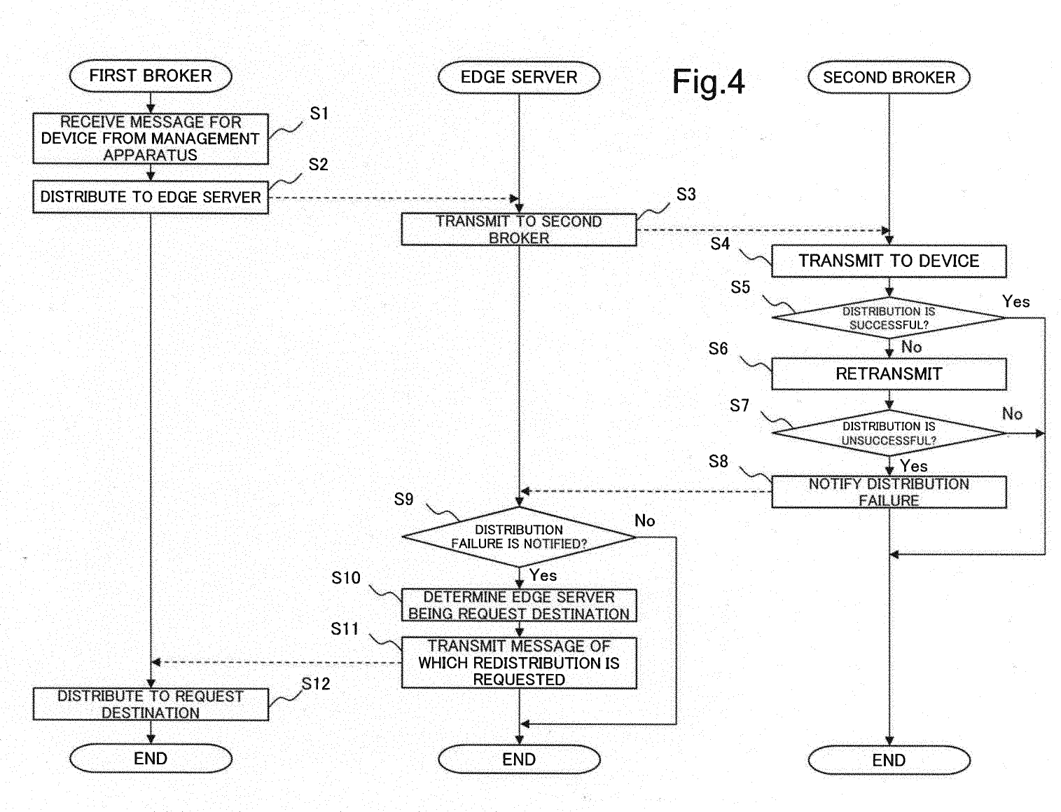

An operation of the thus configured communication system 1 will be described in detail with reference to FIG. 4. It is assumed in the following description of the operation that, as a delivery guarantee level in publish/subscribe communication, a level guaranteeing arrival at a destination (e.g. 1 or 2 in MQTT) is set to a message. An operation on a message set with a level not guaranteeing arrival at a destination (0 in MQTT) as a delivery guarantee level ends in Step S4 below, and therefore description thereof is omitted.

First, the management apparatus 100 transmits a message for a device 200 to the first broker 400. Specifically, the management apparatus 100 publishes a message for a device 200 to a topic in the first broker 400, the topic being related to the device 200. Then, the message distribution unit 401 in the first broker 400 receives the message for the device 200 (Step S1).

Then, the message distribution unit 401 distributes the received message for the device 200 to an edge server 300 handling distribution to the device 200. Specifically, the message distribution unit 401 distributes the message for the device 200 to an edge server 300 stored as a subscriber to a topic receiving the message (Step S2).

Next, the message transmission-reception unit 301 in the edge server 300 receives from the first broker 400 the message for the device 200 to which distribution is handled by the own edge server. Then, the message transmission-reception unit 301 transmits the received message for the device 200 to the second broker 500. Specifically, the message transmission-reception unit 301 publishes the message for the device 200 to a topic in the second broker 500, the topic being related to the device 200 (Step S3).

Next, the message distribution unit 501 in the second broker 500 receives the message for the device 200. Then, the message distribution unit 501 distributes the received message for the device 200 to the device 200. Specifically, the message distribution unit 501 distributes the message to a device 200 stored as a subscriber to the topic receiving the message for the device 200 (Step S4).

When the distribution is successful (Yes in Step S5), the communication system 1 ends the operation.

On the other hand, when the distribution is not successful (No in Step S5), the message distribution unit 501 tries retransmission (Step S6). For example, as described above, the message distribution unit 501 may try retransmission every time a predetermined time elapses.

Next, the distribution status management unit 502 detects whether or not the distribution is unsuccessful (Step S7).

For example, as described above, the distribution status management unit 502 may determine whether or not the distribution is unsuccessful, based on the number of retransmission trials in Step S6, a time elapsed from the first distribution, or the like.

When a distribution failure is not detected (No in Step S7), the message is actually distributed to the device 200 by the retransmission. In this case, the communication system 1 ends the operation.

On the other hand, when a distribution failure is detected (Yes in Step S7), the distribution status management unit 502 notifies the distribution failure to the edge server 300 being a source of the message (Step S8).

Next, when the distribution failure is notified at the edge server 300 (Yes in Step S9), the request destination determination unit 302 determines another edge server 300 being a request destination for redistribution, with respect to the unsuccessfully distributed message for the device 200 (Step S10).

For example, as described above, the request destination determination unit 302 may determine as candidates other edge servers 300 located around the own edge server and determine a request destination from the candidates.

Next, the redistribution request unit 303 transmits to the first broker 400 the message for the device 200, redistribution of the message being requested to an edge server 300 being the determined request destination (Step S11).

Specifically, as described above, the redistribution request unit 303 may publish the relevant message to a redistribution topic in the first broker 400. As the redistribution topic, a redistribution topic based on a combination of the own edge server, the edge server 300 being a request destination, and the device 200 being a redistribution destination is applied.

Next, the message distribution unit 401 in the first broker 400 receives the message of which redistribution is requested. Then, the message distribution unit 401 distributes the requested message to the edge server 300 being the request destination for the redistribution (Step S12).

Specifically, as described above, the message distribution unit 401 may distribute the requested message to an edge server 300 stored as a subscriber to the redistribution topic receiving the message.

Then, when the requested message is received by the edge server 300 being the request destination, the communication system 1 may execute the operations from Step S3.

The above concludes the description of the operation of the communication system 1.

Next, an effect of the first example embodiment of the present invention will be described.

The communication system according to the first example embodiment of the present invention is able to more reliably distribute a message to a mobile device in publish/subscribe communication through a multistage broker configuration.

The reason will be described. According to the present example embodiment, when the management apparatus transmits a message for a device to the first broker, the message distribution unit in the first broker distributes the message to an edge server handling distribution to the relevant device. Then, in order to distribute the received message to the device, the message transmission-reception unit transmits the message to a second broker. Then, the message distribution unit in the second broker distributes the message to the relevant device. Then, when detecting a distribution failure, the distribution status management unit in the second broker notifies the distribution failure to the edge server. Then, in the edge server notified of the distribution failure, the request destination determination unit determines another edge server being a request destination for redistribution of the unsuccessfully distributed message to the device. Then, the redistribution request unit transmits to the first broker the message of which redistribution is requested to the determined other edge server. Then, when receiving the message of which redistribution is requested, the message distribution unit in the first broker distributes the relevant message to the other edge server being the request destination. Then, the other edge server receiving the message of which redistribution is requested transmits the message to the second broker in order to distribute the message to the relevant device.

Consequently, the present example embodiment is able to inhibit a situation that a message transmitted by the management apparatus at a delivery guarantee level guaranteeing arrival at a device is lost by a move of the device, in spite of the message being distributed to an edge server handling distribution to the device.

### Second Example Embodiment

Next, a second example embodiment of the present invention will be described in detail with reference to drawings. In each drawing referred to in the description of the present example embodiment, a configuration identical to and a step operating similarly to those according to the first example embodiment of the present invention are respectively given reference signs identical to those in the first example embodiment, and detailed description thereof in the present example embodiment is omitted.

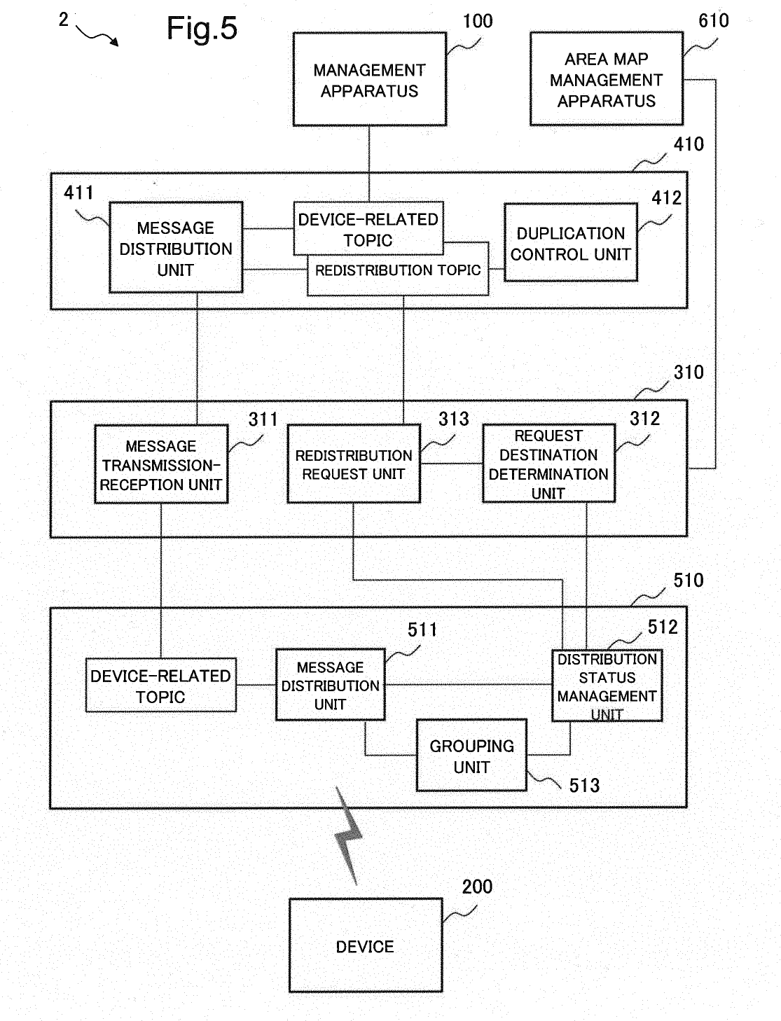

First, FIG. 5 illustrates a functional block configuration of a communication system 2 according to the present example embodiment. The communication system 2 differs from the notification system 1 according to the first example embodiment of the present invention in the following points. Specifically, the communication system 2 includes an edge server 310 in place of the edge server 300, a first broker 410 in place of the first broker 400, and a second broker 510 in place of the second broker 500. Additionally, the communication system 2 includes an area map management apparatus 610. The area map management apparatus 610 and the edge server 310 are communicably connected through a network.

Each apparatus constituting the communication system 2 may be configured with a hardware element similar to that according to the first example embodiment of the present invention described with reference to FIG. 2. Further, the area map management apparatus 610 may be configured with an apparatus including a CPU, a memory, and a network interface. However, the hardware configuration of each apparatus constituting the communication system 2 is not limited to the aforementioned configuration.

First, the area map management apparatus 610 will be described. The area map management apparatus 610 stores area map information indicating a positional relation between edge servers 310. For example, the area map information may be information obtained by associating information for identifying an edge server 310 with information for identifying an edge server 310 located around the edge server 310. Note that it is assumed that an edge server 310 according to the present example embodiment handles distribution for each area. In this case, it is desirable that the area map management apparatus 610 does not store information for identifying a certain edge server 310 in such a way that the information is associated with identification information of another edge server 310 handling distribution in the same area as the edge server 310.

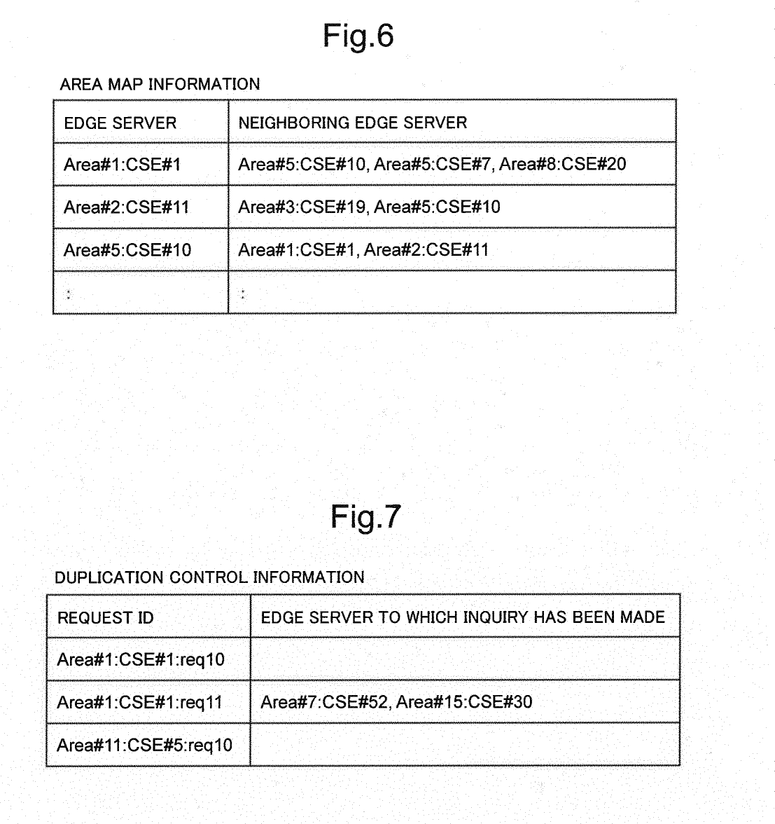

FIG. 6 illustrates an example of area map information. For example, in FIG. 6, “Area#1:CSE#1” indicates a first edge server 310 handling distribution in a first area. In this example, “Area#5:CSE#10”, “Area 5:CSE#7,” and “Area#8:CSE#20” are stored as edge servers 310 located around the edge server 310 “Area#1:CSE#1.” The area map information illustrated in FIG. 6 is an example and a content and a form of the area map information are not limited.

Next, each functional block in the edge server 310 will be described.

In FIG. 5, the edge server 310 includes a message transmission-reception unit 311, a request destination determination unit 312, and a redistribution request unit 313.

The message transmission-reception unit 311 is configured almost similarly to the message transmission-reception unit 301 according to the first example embodiment of the present invention. In addition, when redistribution of a message to a device 200 is completed, the redistribution of the message being requested by another edge server 310, the message transmission-reception unit 311 notifies the redistribution completion to another edge server 310. The completion of the redistribution of the relevant message to the relevant device 200 is notified by the second broker 510. The other edge server 310 being an additional notification destination of the redistribution completion notified by the second broker 510 is another edge server 310 requested similarly to the own edge server for redistribution of the message of which redistribution is completed.

The message transmission-reception unit 311 may provide a redistribution completion notification to such another edge server 310 by a publication to a redistribution topic in the first broker 410.

When notified of a distribution failure of a message to a device 200 from the second broker 510, the request destination determination unit 312 determines another edge server 310 being a request destination for redistribution of the message to the device 200 as follows.

Specifically, the request destination determination unit 312 extracts another edge server 310 located around the own edge server as a candidate of the request destination by referring to area map information stored in the area map management apparatus 610. It is desirable that an edge server 310 handling an area different from the area handled by the own edge server be extracted as a candidate of the request destination. Then, the request destination determination unit 312 determines an edge server 310 being the request destination, based on the extracted candidate.

In detail, the request destination determination unit 312 inquires of each edge server 310 extracted as a candidate of the request destination about whether or not a connection history to the device 200 of which distribution failure is notified exists. For example, the connection history refers to a history of a detection record of connection from the device 200 in an area in which distribution is handled by the own edge server. Then, based on the inquiry result, the request destination determination unit 312 estimates an edge server 310 handling distribution in an area being likely to be a destination of the relevant device 200, out of the candidates. The edge server 310 handling distribution in an area being likely to be a destination is hereinafter also referred to as a destination server.

Then, based on information about the destination server, the request destination determination unit 312 extracts a candidate of a new request destination. Specifically, the request destination determination unit 312 extracts another edge server 310 located around the destination server as a candidate of the new request destination, by referring to the area map information stored in the area map management apparatus 610. It is desirable that an edge server 310 handling an area different from the area handled by the destination server be extracted as a candidate of the new request destination. Then, the request destination determination unit 312 inquires of each edge server 310 being a new candidate about whether or not a connection history to the device 200 of which distribution failure is notified exists, and based on the inquiry result, repeats further estimating a new destination server.

Then, the request destination determination unit 312 determines an edge server 310 being a request destination, based on a destination server at the point when a predetermined condition is satisfied in the repetition processing. For example, the predetermined condition may be a destination server estimated in each round of the repetition processing consecutively being identical a predetermined number of times or more. An edge server 310 being a destination server at the point when a predetermined condition is satisfied is hereinafter also referred to as a destination master server. Then, the request destination determination unit 312 determines as request destinations the destination master server and an edge server 310 located around the destination master server. An edge server 310 located around the destination master server is specifiable by referring to the area map management apparatus 610. At this time, it is desirable that an edge server 310 handling an area different from the area handled by the destination master server be specified as an edge server 310 located around the destination master server.

Further, when an inquiry about a connection history is received from another edge server 310, and a connection history to the relevant device 200 exists, the request destination determination unit 312 returns information about the connection history. The request destination determination unit 312 according to the present example embodiment acquires the connection history about the relevant device 200 by referring to a topic management table held in a second broker 510 in an area in which distribution is handled by the own edge server. The topic management table will be described later. Further, it is assumed that a connection history includes a connection time when connection of the relevant device 200 is detected. Then, in response to the inquiry about a connection history from the other edge server 310, the request destination determination unit 312 returns as the inquiry result the latest connection time out of connection times related to the device 200, the connection times being acquired from the topic management table.

Further, when receiving an inquiry about a connection history from another edge server 310, the request destination determination unit 312 may thereafter operate in a monitor mode. In the monitor mode, every time connection by a device 200 about which the inquiry is made is newly detected, the request destination determination unit 312 returns a connection time thereof to the edge server 310 being an inquiry source. In this case, the request destination determination unit 312 operates in the monitor mode until information indicating a cancellation instruction of the monitor mode is received from the first broker 410.

The request destination determination unit 312 provides transmission and reception of an inquiry about a connection history and the inquiry result to and from the request destination determination unit 312 in another edge server 310 by publication and subscription to a redistribution topic in the first broker 410.

When a distribution failure is notified from the second broker 510, the redistribution request unit 313 requests collective redistribution of messages for a device 200 to which the distribution failure is detected to an edge server 310 being a request destination. Specifically, the redistribution request unit 313 may collectively acquire from the second broker 510 messages of which distribution to the relevant device 200 is not completed. Then, the redistribution request unit 313 may publish each of the collectively acquired messages to a redistribution topic in the first broker 410.

Further, when the redistribution request is completed, the redistribution request unit 313 notifies the second broker 510 of the completion of the request.

Next, each functional block in the first broker 410 will be described.

In FIG. 5, the first broker 410 includes a message distribution unit 411 and a duplication control unit 412.

The message distribution unit 411 distributes a message of which redistribution is requested by a certain edge server 310 to each edge server 310 being a request destination. Further, the message distribution unit 411 distributes an inquiry about a connection history to a certain device 200, the inquiry being transmitted from a certain edge server 310, to an edge server 310 extracted by the duplication control unit 412, to be described later, out of respective edge servers 310 being candidates of a request destination. Further, the message distribution unit 411 distributes an inquiry result returned from each edge server 310 being a candidate of the request destination to the edge server 310 being the inquiry source. Further, the message distribution unit 411 distributes a redistribution completion notification transmitted from an edge server 310 being the request destination to each edge server 310 to which redistribution of the same message is requested. The message distribution unit 411 performs transmission and reception of the information through a redistribution topic.

Further, when receiving a message of which redistribution is requested, the message distribution unit 411 distributes information indicating cancellation of the aforementioned monitor mode to an edge server 310 in the monitor mode with respect to a device 200 being a destination of the message. The reason is that a request destination for redistribution is already determined with respect to the message of which redistribution is requested, and therefore the monitor mode for determining the request destination for the redistribution is no longer necessary. Specifically, when receiving a message of which redistribution is requested, the message distribution unit 411 may publish a message instructing cancellation to a redistribution topic to which an inquiry about a device 200 being a destination of the message has been published in the past.

The duplication control unit 412 controls an inquiry about a connection history from an edge server 310 to another edge server 310 in such a way as to avoid duplicate transmission of the inquiry to the same edge server 310. Specifically, when receiving an inquiry about a connection history from an edge server 310, the duplication control unit 412 extracts an edge server 310 to which the same inquiry has not been transmitted in the past out of edge servers 310 being destinations of the inquiry and notifies the extracted server to the message distribution unit 411.

For example, the duplication control unit 412 may hold duplication control information as illustrated in FIG. 7. In the example in FIG. 7, the duplication control information is information obtained by associating a request ID identifying an unsuccessfully distributed message with information for identifying an edge server 310 to which an inquiry about a connection history of a device 200 being a destination of the message has been already made. The duplication control unit 412 may extract an edge server 310 to which the same inquiry has not been transmitted in the past, by excluding an edge server 310 to which the inquiry has already been made, the server being recorded in the duplication control information, from edge servers 310 being inquiry destinations about the connection history.

Next, each functional block in the second broker 510 will be described.

In FIG. 5, the second broker 510 includes a message distribution unit 511, a distribution status management unit 512, and a grouping unit 513.

The message distribution unit 511 is configured almost similarly to the message distribution unit 501 according to the first example embodiment of the present invention. An example of the message distribution unit 511 according to the present example embodiment functioning by use of a message management table, a topic management table, and a distribution status table will be described.

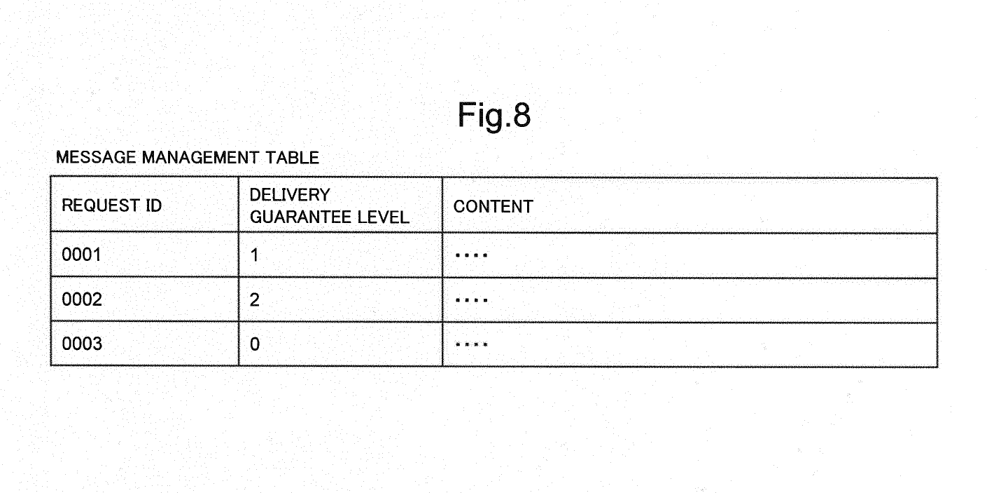

The message management table is a table for managing a content of a message received at a topic in the own second broker. FIG. 8 illustrates an example of the message management table.

In FIG. 8, a request ID is information for identifying a message. For example, in the example in FIG. 8, a message with a request ID “0001” is set with 1 based on MQTT as a delivery guarantee level (QoS). Further, the message management table includes a content of each message. When a message is received at a topic, the message distribution unit 511 saves information about the received message into the message management table. A message in the message management table is saved until distribution of the message is completed or redistribution of the message is requested to another edge server.

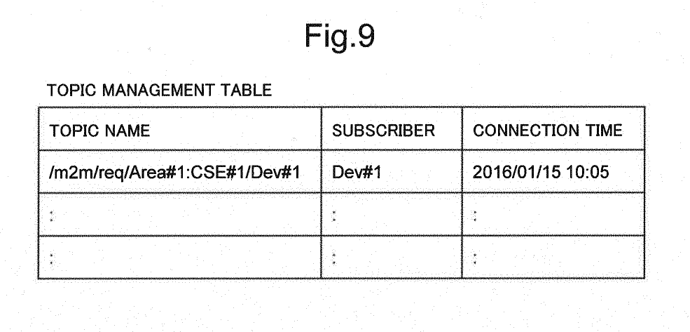

The topic management table is information obtained by associating a topic set to the own second broker with a subscriber thereto. Further, the topic management table includes a time when the subscriber is registered. The time when a subscriber is registered is assumed to be equivalent to a time when the subscriber is connected, and therefore the time when the subscriber is registered is hereinafter also referred to as a connection time. FIG. 9 illustrates an example of the topic management table.

In FIG. 9, for example, a topic “/m2m/req/Area#1:CSE#1/Dev#1” is a topic for a message distributed from an edge server 310 identified as “Area#1:CSE#1” to a device 200 identified as “Dev#1.” Further, in FIG. 9, the device 200 identified as “Dev#1” is associated as a subscriber to the topic. Further, a connection time when the device 200 identified as “Dev#1” is registered as a subscriber to the topic is “2016/01/15 10:05.” The message distribution unit 511 may save the topic, a subscriber thereto, and a connection time thereof into the topic management table when detecting connection of the device 200 identified as “Dev#1.” Further, in response to an inquiry about a connection history from an edge server 310, the message distribution unit 511 searches for and returns a connection time of the relevant device 200 in the topic management table.

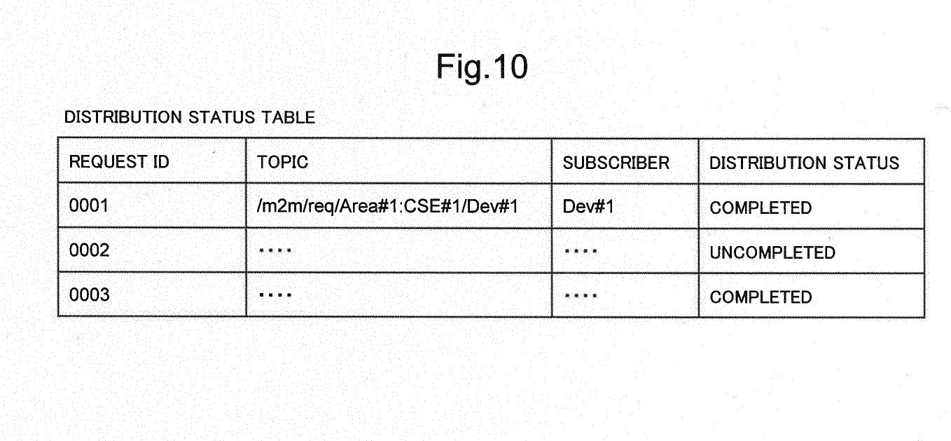

The distribution status table is a table storing distribution status of a message received at a topic in the own second broker. FIG. 10 illustrates an example of the distribution status table.

In FIG. 10, for example, the first row indicates that, with respect to a message with a request ID “0001,” a topic is “/m2m/req/Area#1:CSE#1/Dev#1” and distribution to a device 200 “Dev#1” is completed. For example, the message distribution unit 511 may update the distribution status table every time distribution or retransmission of a message is executed.

Various kinds of information illustrated in FIGS. 8 to 10 are also used by each of the other functional blocks in the second broker 510.

The grouping unit 513 collectively extracts messages distributed to a specified device 200 out of messages distributed from the own second broker. Specifically, for example, the grouping unit 513 may refer to the aforementioned topic management table and message management table. In that case, the grouping unit 513 extracts a topic to which the specified device 200 is stored in the topic management table as a subscriber. Then, the grouping unit 513 may collectively extract messages in the topic extracted from the aforementioned message management table.

The distribution status management unit 512 is configured almost similarly to the distribution status management unit 502 according to the first example embodiment of the present invention. In addition, when detecting a failure in distribution of a message to a device 200, the distribution status management unit 512 extracts a message distributed to the device 200 by use of the grouping unit 513. Then, the distribution status management unit 512 controls the message distribution unit 511 in such a way as to stop retransmission of the extracted message to the device 200.

Further, with respect to a device 200 being a destination of a message of which a distribution failure is detected, the distribution status management unit 512 returns messages extracted by use of the grouping unit 513 in response to an inquiry from the redistribution request unit 313 in an edge server 310.

Further, the distribution status management unit 512 deletes from the aforementioned message management table a message of which a request for redistribution to an edge server 310 is completed by the redistribution request unit 313 in another edge server 310. The distribution status management unit 512 deletes the relevant message by being notified of request completion by the redistribution request unit 313 in the other edge server 310.

An operation of the communication system 2 configured as described above will be described with reference to drawings.

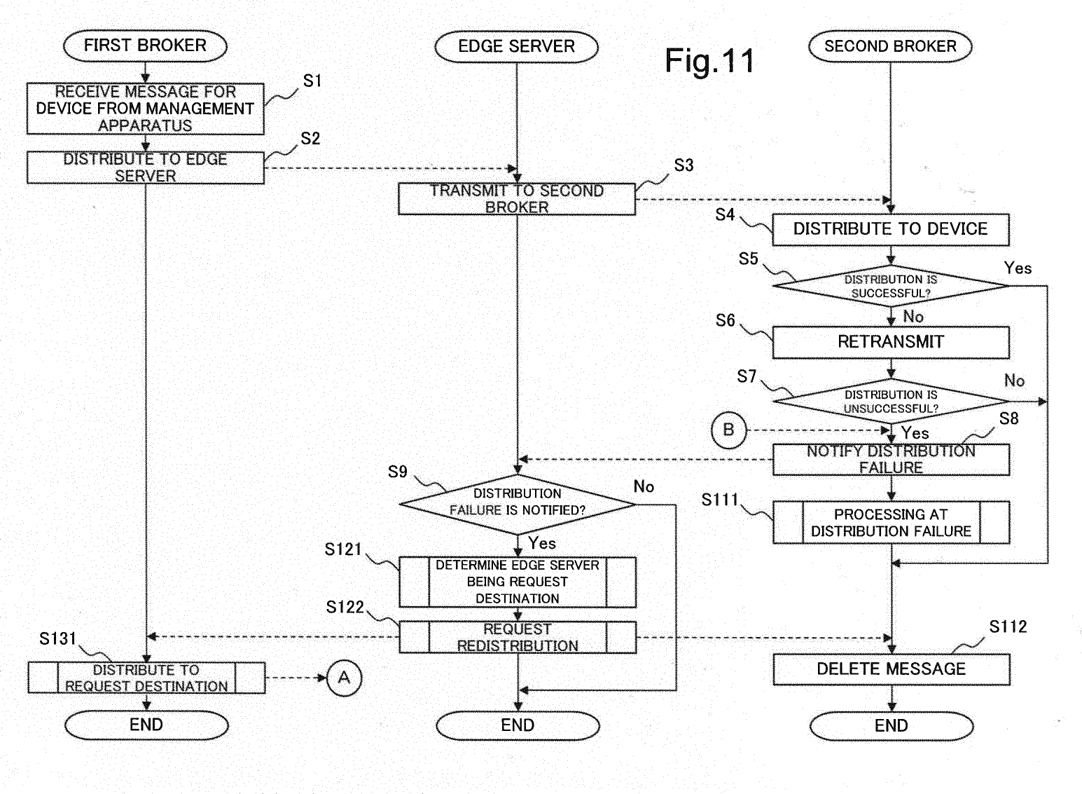

First, FIG. 11 illustrates an outline of the operation of the communication system 2. In the following description of the operation, similarly to the description of the operation in the first example embodiment of the present invention, it is assumed that, as a delivery guarantee level in publish/subscribe communication, a level guaranteeing arrival at a destination is set to a message. An operation on a message set with a level not guaranteeing arrival at a destination as a delivery guarantee level ends in Step S4 in FIG. 11, and therefore description thereof is omitted.

First, the communication system 2 operates similarly to the first example embodiment of the present invention in Steps S1 to S9. Consequently, a message transmitted to a device 200 by the management apparatus 100 is distributed to the device 200 by a second broker 510, and when the distribution is unsuccessful, the distribution failure is notified to an edge server 310.

Further, subsequently to notifying the distribution failure in Step S8, the distribution status management unit 512 in the second broker 510 executes processing at a distribution failure (Step S111). Details of the step will be described later.

Next, the distribution status management unit 512 deletes from the message management table a successfully distributed message or an unsuccessfully distributed message of which a redistribution request to another edge server 310 is completed (Step S112). Completion of the redistribution request is notified in Step S122 to be described later.

Further, in the edge server 310 notified of the distribution failure, the request destination determination unit 312 executes processing of determining a request destination for redistribution of the relevant message to the device 200 (Step S121). Details of the step will be described later.

Next, the redistribution request unit 313 transmits to the first broker 410 the message of which redistribution is requested to the edge server 310 being the determined request destination (Step S122). Details of the step will be described later.

Next, the message distribution unit 411 in the first broker 410 distributes, to the edge server 310 being the request destination, the message of which redistribution is requested (Step S131). Details of the step will be described later.

The above concludes the outline of the operation of the communication system 2.

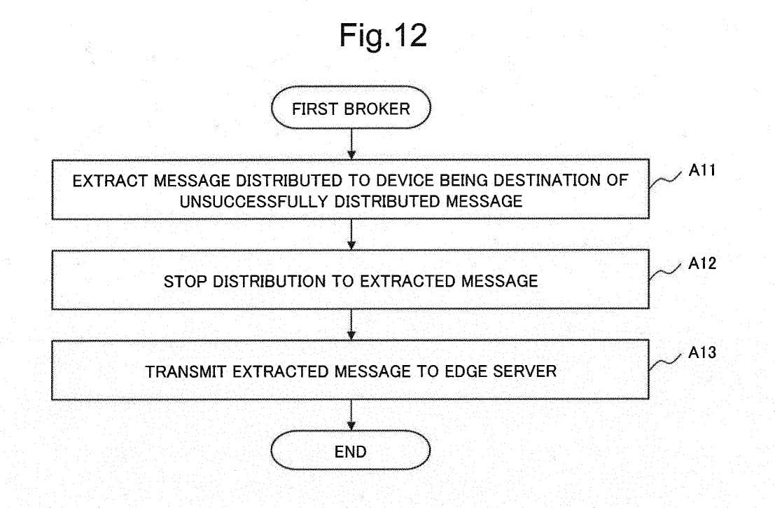

Next, FIG. 12 illustrates details of the processing in Step S111 executed by the second broker 510 at a distribution failure.

In FIG. 12, first, by use of the grouping unit 513, the distribution status management unit 512 in the second broker 510 collectively extracts messages distributed to the device 200 being the destination of the unsuccessfully distributed message, out of messages distributed from the own second broker (Step A11).

Next, the distribution status management unit 512 controls the message distribution unit 511 in such a way as to stop distribution to the collectively extracted messages (Step A12).

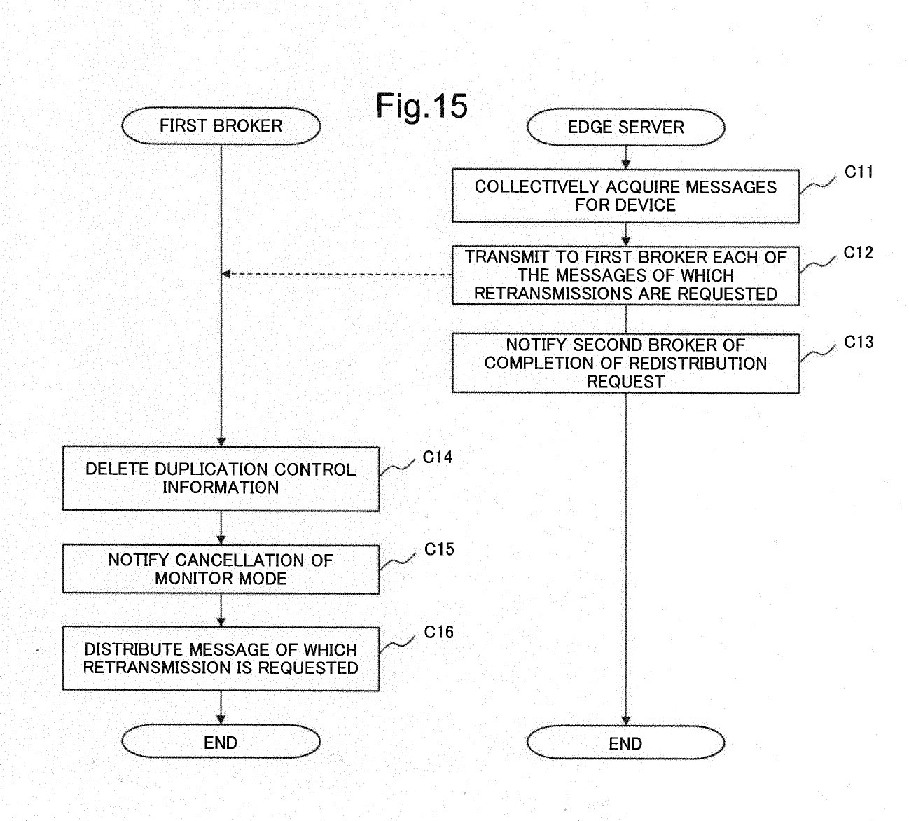

Next, the distribution status management unit 512 transmits the collectively extracted messages to the edge server 310 being the distribution source of the unsuccessfully distributed message (Step A13). The step may be executed in response to a request from the edge server 310 (Step C11 in FIG. 15 to be described later).

The above concludes the operation by the second broker 510 at a distribution failure.

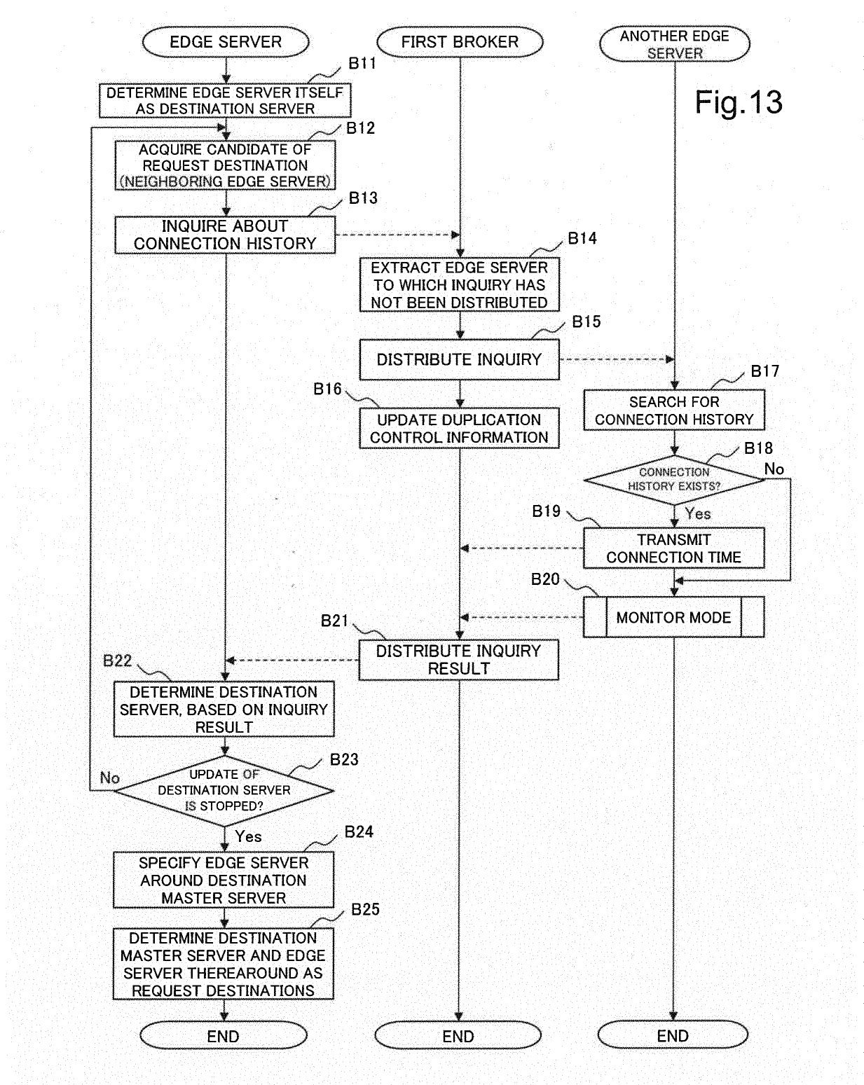

Next, FIG. 13 illustrates details of the processing of the edge server 310 determining a request destination in Step S121. In the processing of determining a request destination, the edge server 310 determines a request destination by transmitting and receiving information to and from another edge server 310 through the first broker 410.

In FIG. 13, first, the request destination determination unit 312 in the edge server 310 determines the own edge server as a destination server (Step B11).

Next, by referring to the area map management apparatus 610, the request destination determination unit 312 acquires another edge server 310 located around the destination server as a candidate of a request destination (Step B12).

Next, the request destination determination unit 312 transmits to the first broker 410 a message inquiring of each edge server 310 being a candidate of the request destination about a connection history of the device 200 being the destination of the unsuccessfully distributed message (Step B13). As described above, the request destination determination unit 312 may publish the inquiry message to a redistribution topic in the first broker 410.

Next, the message distribution unit 411 in the first broker 410 receives the inquiry message. Then, the duplication control unit 412 extracts an edge server 310 to which the same inquiry message has not been distributed in the past, out of respective edge servers 310 being inquiry destinations (Step B14).

The inquiry message includes a request ID identifying the unsuccessfully distributed message. Further, the duplication control unit 412 stores the aforementioned duplication control information. Then, the duplication control unit 412 may exclude an edge server 310 indicated by information associated with the relevant request ID in the duplication control information, out of edge servers 310 stored as subscribers to a redistribution topic receiving the inquiry message.

Next, the message distribution unit 411 in the first broker 410 distributes the inquiry message to each edge server 310 extracted in Step B14 (Step B15).

Next, in response to the distribution of the inquiry message, the duplication control unit 412 updates the duplication control information (Step B16).

Specifically, the duplication control unit 412 may add identification information of the edge server 310 to which the inquiry message is distributed to the duplication control information associated with the request ID identifying the unsuccessfully distributed message and associate the identification information of the edge server 310 with the duplication control information. When duplication control information of the relevant request ID does not yet exist, the duplication control unit 412 may newly generate the information.

Next, in another edge server 310 being a candidate of the request destination, the request destination determination unit 312 receives the inquiry message. Then, the request destination determination unit 312 searches for a connection history to the relevant device 200 (Step B17).

Specifically, the request destination determination unit 312 may search for the connection history by inquiring of a second broker 510 in an area in which the own edge server handles distribution about a content of the topic management table.

When the connection history exists (Yes in Step B18), the request destination determination unit 312 transmits to the first broker 410 information including a connection time as the inquiry result (Step B19). As described above, the request destination determination unit 312 may publish a message indicating the inquiry result to the redistribution topic in the first broker 410.

Next, in the other edge server 310, the request destination determination unit 312 operates in a monitor mode (Step B20). Details of the monitor mode will be described later.

Next, the message distribution unit 411 in the first broker 410 distributes the received inquiry result to the edge server 310 being the inquiry source (Step B21).

Next, in the edge server 310 being the inquiry source, the request destination determination unit 312 estimates a new destination server, based on the inquiry results received from the respective edge servers 310 being candidates of the request destination (Step B22). For example, the request destination determination unit 312 may estimate as a new destination server an edge server 310 from which an inquiry result including the latest connection time is obtained.

Next, the request destination determination unit 312 determines whether or not update of the destination server is stopped (Step B23). For example, the request destination determination unit 312 may determine that update is stopped when the destination server estimated in Step B22 is not updated a predetermined number of times or more.

When the update of the destination server is not stopped, the request destination determination unit 312 repeats the processing from Step B12.

A case of the update of the destination server being stopped on the other hand will be described. In this case, the request destination determination unit 312 determines the destination server at this point as a destination master server. Then, the request destination determination unit 312 acquires another edge server 310 located around the destination master server by referring to the area map management apparatus 610 (Step B24).

Then, the request destination determination unit 312 determines the destination master server and the other edge server 310 located therearound as edge servers 310 being request destinations of redistribution (Step B25).

The above concludes the operation of determining a request destination for redistribution by the edge server 310.

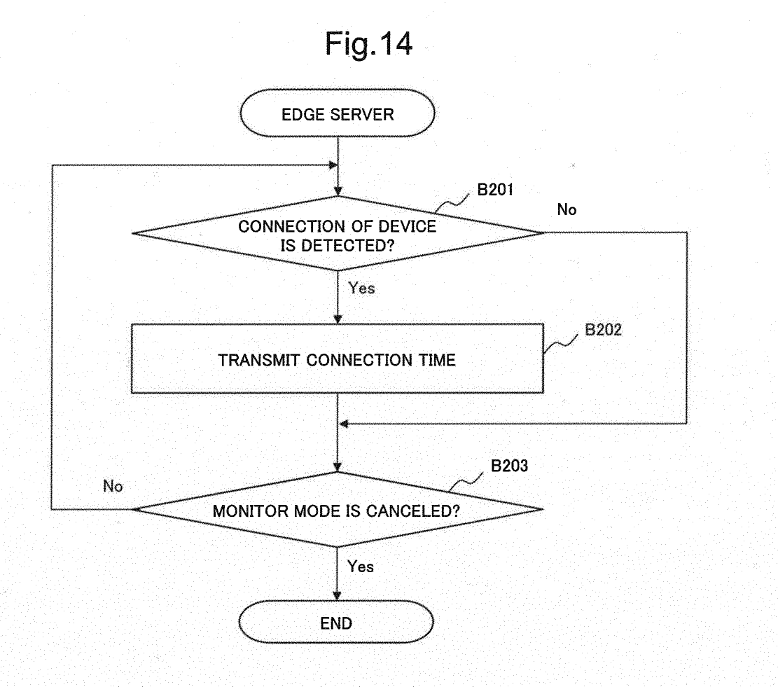

Next, the operation of the edge server 310 in the monitor mode in Step B20 will be described with reference to FIG. 14.

In FIG. 14, first, the request destination determination unit 312 determines whether or not connection of the device 200 being the inquiry target is detected (Step B201).

As described above, the request destination determination unit 312 may determine whether or not connection is detected, by inquiring of the second broker 510 about a content of the topic management table.

When connection of the device 200 is detected, the request destination determination unit 312 transmits to the first broker 410 the inquiry result including a connection time (Step B202).

As described above, the request destination determination unit 312 may publish a message indicating the inquiry result to the redistribution topic in the first broker 410.

Next, the request destination determination unit 312 determines whether or not the monitor mode is canceled (Step B203).

The request destination determination unit 312 also executes the step when connection of the device 200 is not detected in Step B201.

When the monitor mode is not canceled, the request destination determination unit 312 repeats the operations from Step B201. On the other hand, when the monitor mode is canceled, the edge server 310 ends the operation in the monitor mode.

The above concludes the description of the operation of the monitor mode in the edge server 310.

Next, FIG. 15 illustrates the detailed operations of the edge server 310 and the first broker 410 requesting redistribution of the unsuccessfully distributed message and distributing the message in Steps S122 and S131.

In FIG. 15, first, the redistribution request unit 313 in the edge server 310 acquires from the second broker 510 messages for the device 200 being the same as the destination of the unsuccessfully distributed message (Step C11). The redistribution request unit 313 may execute the step by requesting the second broker 510 to execute Step A13 in FIG. 12 described above.

Next, the redistribution request unit 313 transmits to the first broker 410 each message received in Step C11, in order to request redistribution of each of the messages to each of the other edge servers 310 determined as request destinations (Step C12).

As described above, the redistribution request unit 313 may publish each relevant message to the redistribution topic in the first broker 410.

Next, the redistribution request unit 313 notifies the second broker 510 of completion of the redistribution request (Step C13).

Next, the duplication control unit 412 in the first broker 410 deletes duplication control information about the received message (Step C14). The reason is that duplication control of inquiry about a connection history is no longer necessary for the device 200 being the destination of the messages.

Next, the message distribution unit 411 notifies cancellation of the monitor mode to each edge server 310 to which the inquiry about a connection history with respect to the device 200 being the destination of the message is already distributed (Step C15).

For example, the message distribution unit 411 may notify cancellation of the monitor mode to each relevant edge server 310 by publishing a message indicating a cancellation instruction to a redistribution topic in the own first broker.

In an edge server 310 notified of cancellation of the monitor mode, the determination result in B203 in FIG. 14 becomes Yes and the monitor mode ends.

Next, the message distribution unit 411 distributes the message of which redistribution is requested, to each edge server 310 being a request destination of the message (Step C16).

The above concludes the detailed description of the operations in Steps S122 and S131 in FIG. 11.

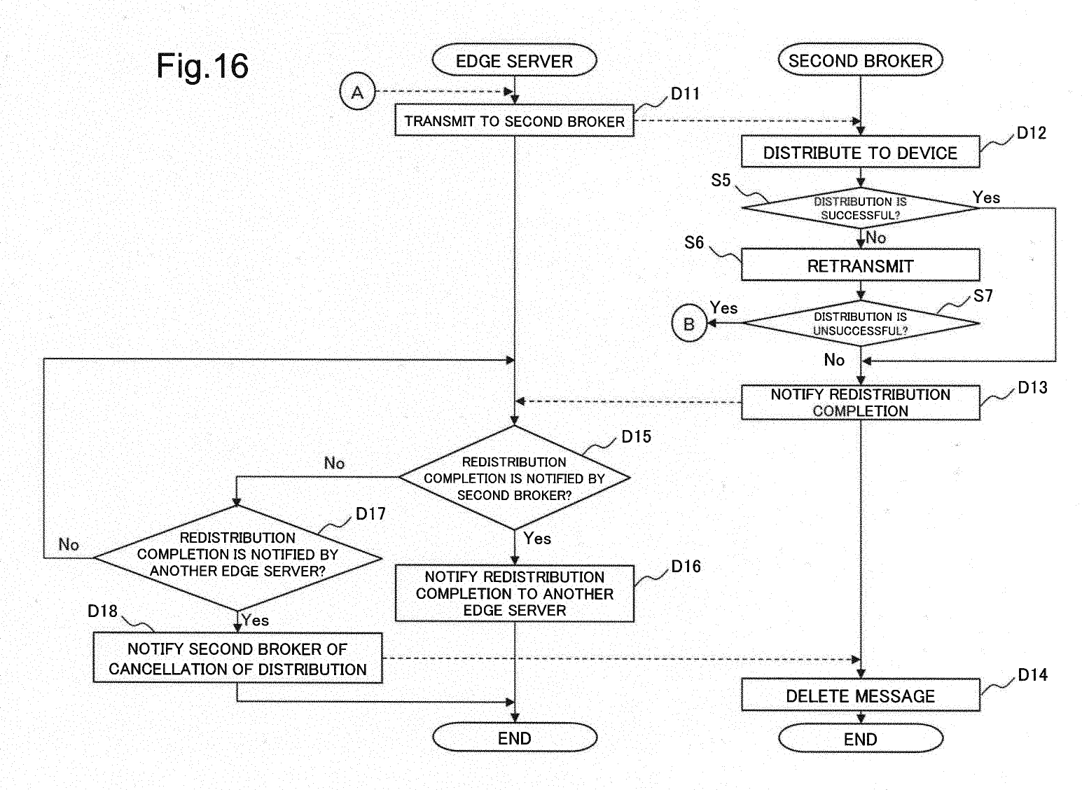

Next, FIG. 16 illustrates details of the operation of the communication system 2 redistributing a message subsequently to the operation in Step S131 in FIG. 11.

In FIG. 16, first, in the edge server 310 to which redistribution is requested, the message transmission-reception unit 311 transmits to the second broker 510 a message of which redistribution is requested (Step D11).

Specifically, the message transmission-reception unit 311 may publish to a topic in the second broker 510, the topic being related to the device 200, the message of which redistribution is requested.

Next, the message distribution unit 511 in the second broker 510 distributes to the device 200 the message of which redistribution is requested (Step D12).

When the distribution is not successful (No in Step S5), the second broker 510 executes Steps S6 and S7 described with reference to FIG. 11. Consequently, the second broker 510 retransmits the message and determines whether or not the distribution is unsuccessful.

When the distribution is determined to be unsuccessful in Step S7, the communication system 2 operates similarly to Step S8 and beyond illustrated in FIG. 11. However, when the edge server itself is a destination master server, the edge server 310 being the request source notified of the distribution failure executes Step S9 and beyond. When the edge server 310 being the request source notified of the distribution failure is an edge server 310 around the destination master server, the operation may be ended without executing Step S9 and beyond.

On the other hand, when the redistribution is determined to be successful in Step S5, or the distribution is determined to be not unsuccessful in Step S7 (i.e. the redistribution becoming successful by retransmission), the message distribution unit 511 operates as follows. In this case, the message distribution unit 511 notifies redistribution completion to the edge server 310 being the distribution source (Step D13).

Then, the message distribution unit 511 deletes from the message management table the message of which redistribution is completed (Step D14).

Next, in the edge server 310, when the redistribution completion notification is received from the second broker 510 (Yes in Step D15), the redistribution request unit 313 notifies redistribution completion to another edge server 310 (Step D16).

The other edge server 310 being a notification destination of the redistribution completion is an edge server 310 to which redistribution of the relevant message is requested along with the own edge server. For example, in the edge server 310 receiving the redistribution completion notification from the second broker 510, the redistribution request unit 313 specifies a destination master server being a request destination for the redistribution along with the own edge server. The own edge server may be the destination master server. Then, the redistribution request unit 313 acquires information indicating the destination master server and an edge server 310 located therearound excluding the own edge server, with reference to the area map management apparatus 610. The edge server 310 indicated by the acquired information is an edge server 310 to which redistribution of the same message is requested along with the own edge server. Then, the redistribution request unit 313 may notify the redistribution completion to the edge servers 310.

Notification of redistribution completion between edge servers 310 is performed through a redistribution topic in the first broker 410.

A case of receiving, in the edge server 310, a redistribution completion notification from another edge server 310 on the other hand (No in Step D15 and Yes in D17) will be described. In this case, the redistribution request unit 313 notifies the second broker 510 of cancellation of distribution of the message of which redistribution is requested (Step D18).

Then, the message distribution unit 511 in the second broker 510 deletes the relevant message and cancels the distribution (Step D14).

The above concludes the operation of redistributing a message by the communication system 2.

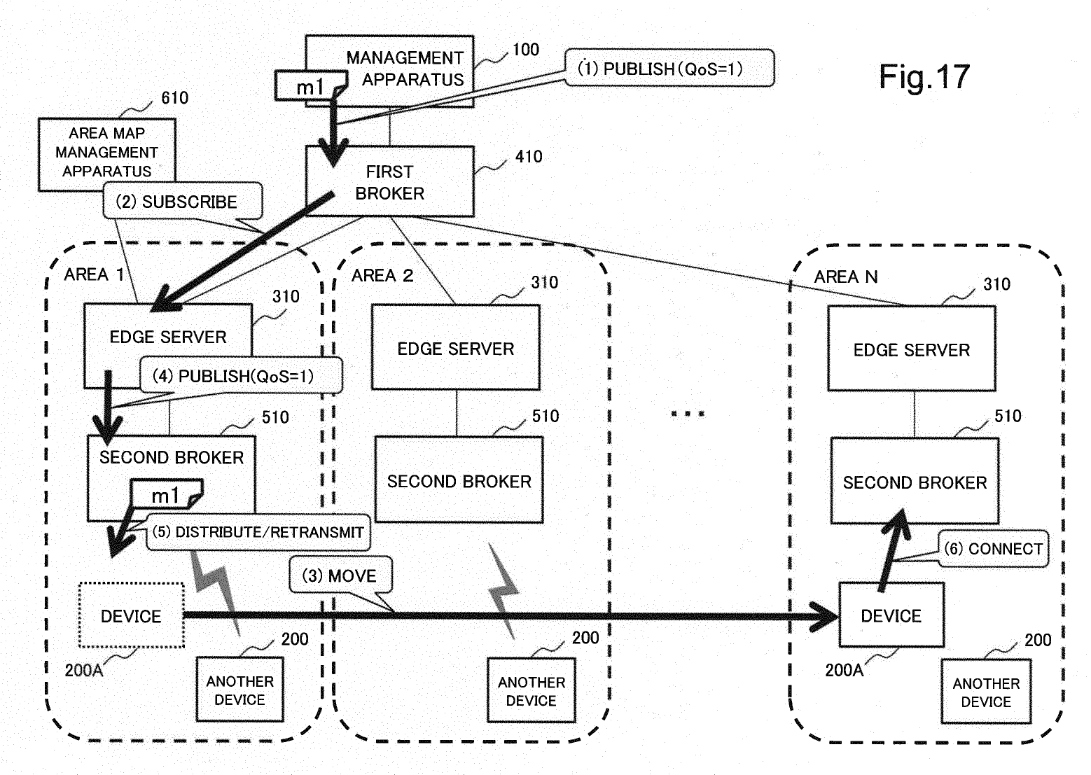

Next, a specific example of the operation of the communication system 2 will be described by use of FIGS. 17 to 21.

In FIGS. 17 to 21, a movable spatial range of a device 200 is divided into N areas being areas 1 to N. N is a positive integer. Further, in an area i (i=1 to N), at least one edge server 310 handling distribution to a device 200 existing in the area is provided. Depending on an area, a plurality of edge servers 310 may be provided. Further, in the area i, at least one second broker 510 relaying a message distributed from an edge server 310 in the area to a device 200 existing in the area is provided. Depending on an area, a plurality of second brokers 510 may be provided.

Further, in FIGS. 17 to 21, one management apparatus 100 manages devices 200. Further, one first broker 410 is provided in order to connect the management apparatus 100 with an edge server 310 in each area.

Further, in this specific example, various kinds of sensors are equipped on a device 200. A device 200 is configured to receive a message in a topic related to a sensor equipped on the device itself. Specifically, a device 200 connects to a second broker 510 in the area the device itself exists and registers a subscription to a topic related to the own device and a sensor equipped on the own device.

In such a specific example, it is assumed that the management apparatus 100 distributes to a device 200 a message for managing a sensor on the device 200. A device 200 being a distribution target is denoted as a device 200A. Initially, the device 200A is assumed to exist in an area 1. A target sensor is denoted as a sensor a. Further, a relevant message is denoted as a message m1.

(1) First, in FIG. 17, the management apparatus 100 distributes the message m1 for the device 200A for managing the sensor a to an edge server 310 in the area 1 through the first broker 410 (Steps S1 and S2 in FIG. 11).

Note that it is assumed that the management apparatus 100 acquires information indicating that an area in which the device 200A exists is the area 1 from outside. It is further assumed that MQTT is employed as a communication protocol, and the message m1 is transmitted with 1 set as a delivery guarantee level.

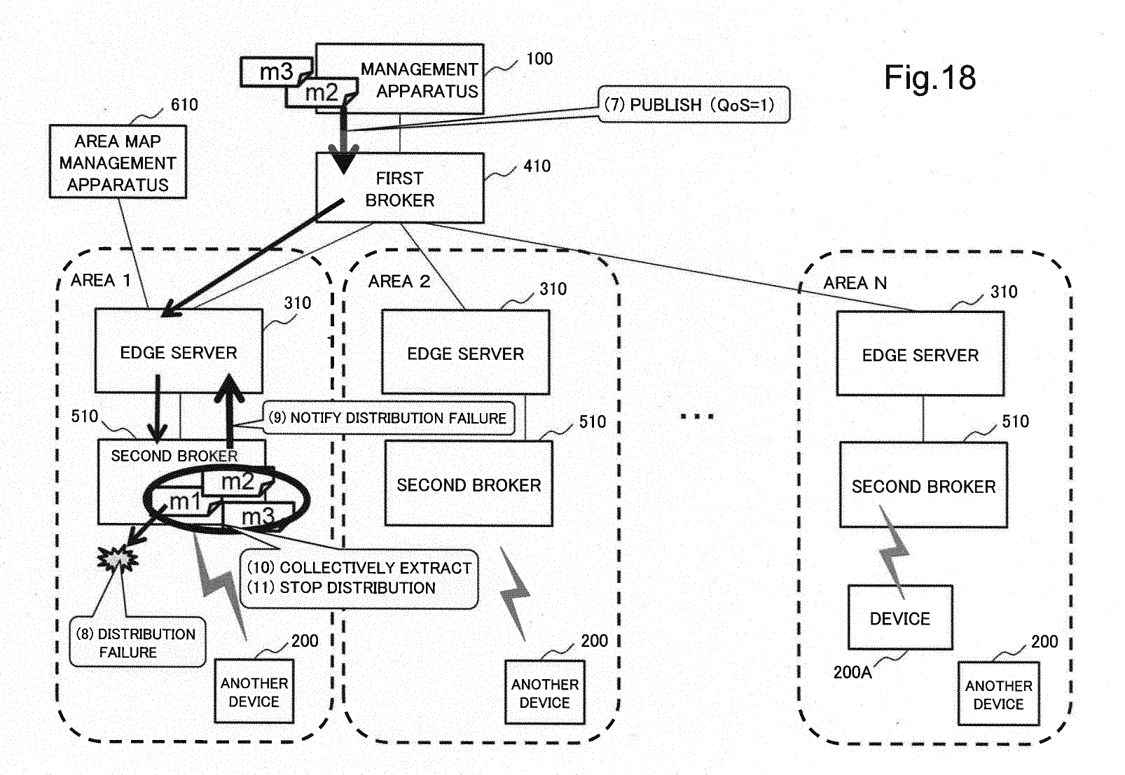

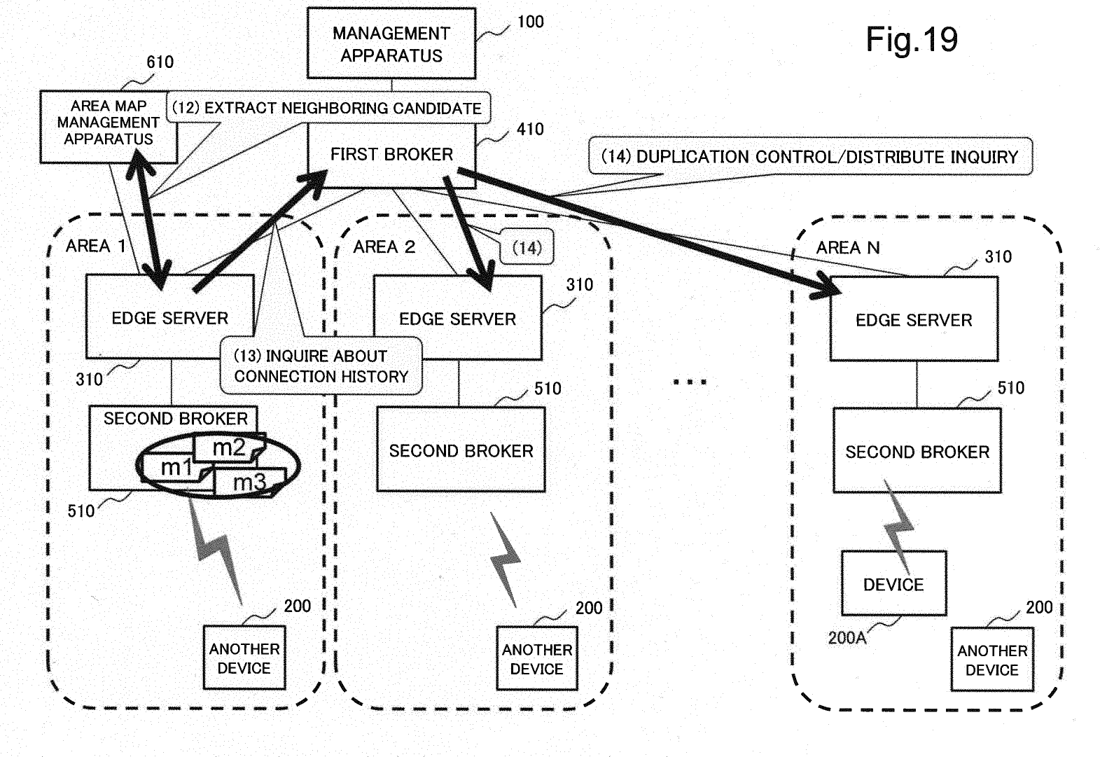

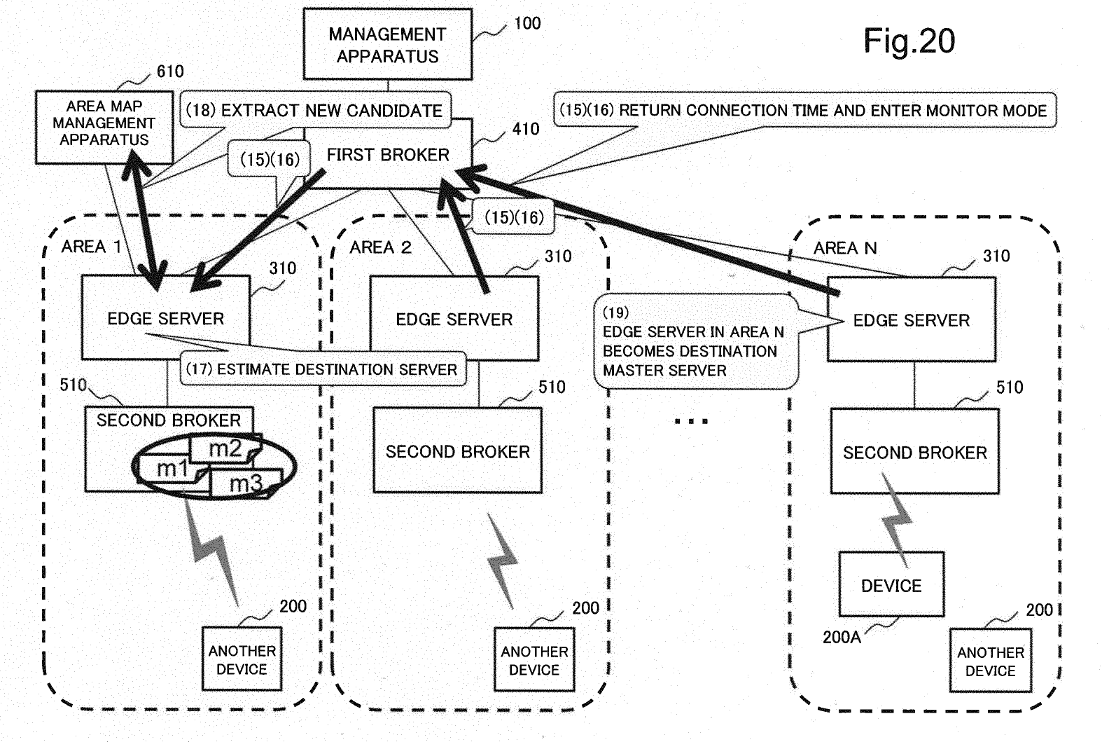

(2) It is assumed that the edge server 310 in the area 1 has detected connection of the device 200A in the area 1 handled by the edge server itself and therefore has registered a subscription to a topic related to the device 200A in the first broker 410. Then, the edge server 320 in the area 1 receives the message m1.
(3) Next, it is assumed that the device 200A moves and no longer exists in the area A. However, the edge server 310 in the area 1 does not detect nonexistence of the device 200A in the area A at this stage.
(4) Then, the edge server 310 in the area 1 transmits the message m1 to the second broker 510 in order to distribute the message to the device 200A (Step S3). The message m1 is transmitted with 1 set as a delivery guarantee level.
(5) Next, in the second broker 510, the message distribution unit 511 receives the message m1 and saves the message into a message management table. Then, the message distribution unit 511 distributes the message m1 to the device 200A (Step S4). However, since the device 200A does not exist in the area A, the message distribution unit 511 tries retransmission of the message m1 to the device 200A (No in S5 and S6).
(6) Next, the device 200A moves while passing through other areas and stops moving at an area N. Then, it is assumed that the device 200A registers a subscription to a topic related to the sensor on the own device in a second broker 510 in the area N.
(7) Next, in FIG. 18, the management apparatus 100 further distributes messages m2 and m3 for managing other sensors b and c on the device 200A, respectively. It is assumed that the management apparatus 100 still acquires information that the device 200A exists in the area 1 at this point. Then, the management apparatus 100 distributes the messages m2 and m3 toward the edge server 310 in the area 1 through the first broker 410 (Steps S1 and S2 in FIG. 11). The messages m2 and m3 are transmitted with 1 respectively set as a delivery guarantee level.
(8) Each functional block respectively operates on the messages m2 and m3, similarly to (2) to (4) described above, and the messages m2 and m3 are added to the message management table in the second broker 510 in the area 1. Then, the distribution status management unit 512 in the second broker 510 in the area 1 determines that distribution of the message m1 is unsuccessful, based on a retransmission count or the like (Yes in Step S7).
(9) Then, the distribution status management unit 512 notifies the edge server 310 in the area 1 of the distribution failure (Step S8).
(10) Further, by use of the grouping unit 513, the distribution status management unit 512 in the second broker 510 in the area 1 collectively extracts the messages m1 to m3 for the device 200A, unsuccessful distribution of the messages being detected (Step S111 and Step A11 in FIG. 12).
(11) Then, the distribution status management unit 512 in the second broker 510 in the area 1 controls the message distribution unit 511 in such a way as to stop distribution processing of the extracted messages m1 to m3 (Step A12).
(12) Next, in FIG. 19, the request destination determination unit 312 in the edge server 310 in the area 1 notified of the distribution failure makes an inquiry to the area map management apparatus 610. Consequently, the request destination determination unit 312 specifies another edge server 310 being a candidate of a request destination (Step S121 in FIG. 11 and Step B12 in FIG. 13).
(13) Next, the request destination determination unit 312 in the edge server 310 in the area 1 inquires of the other edge server 310 being a candidate of the request destination about a connection history of the device 200A (Step B13). At this time, the inquiry is transmitted and received through a redistribution topic in the first broker 410.
(14) Next, the duplication control unit 412 in the first broker 410 refers to duplication control information and excludes from inquiry destinations an edge server 310 to which an inquiry about a connection history with respect to the device 200A being the destination of the target message m1 is already made (Step B14). Then, the message distribution unit 411 distributes an inquiry message to the inquiry destinations (Step B15). Then, the duplication control unit 412 additionally records the inquiry destinations with respect to the device 200A being the destination of the target message m1 into the duplication control information (Step B16).
(15) Next, in FIG. 20, the request destination determination unit 312 in an edge server 310 in another area receiving the inquiry acquires a connection history of the device 200A from a topic management table in a second broker 510 (Step B17). Then, when a connection history of the relevant device 200A is obtained, the request destination determination unit 312 in the edge server 310 in the other area returns a connection time as an inquiry result. Return of the connection time is performed through a redistribution topic in the first broker 410 (Yes in Step B18 and B19).
(16) Further, the request destination determination unit 312 in the edge server 310 in the other area receiving the inquiry message enters the monitor mode and checks a connection history of the device 200A at predetermined intervals. Then, when a connection history of the device 200A is newly obtained, the request destination determination unit 312 in the edge server 310 in the other area returns a connection time as an inquiry result (Steps B20 and B21).
(17) Next, the request destination determination unit 312 in the edge server 310 in the area 1 receiving the inquiry result estimates a destination server out of candidates of the request destination, based on the inquiry result. For example, it is assumed that an edge server 310 in an area 3 is estimated as a destination server (Step B22).
(18) By making an inquiry to the area map management apparatus 610, the request destination determination unit 312 in the edge server 310 in the area 1 specifies another edge server 310 being a candidate of a new request destination, based on the edge server 310 in the area 3 being the destination server. Then, the operations from (13) are repeated (Steps B12 to B22).

Then, it is assumed that, in the repeated operation in (17), an edge server 310 in an area N is consecutively estimated as a destination server a predetermined number of times (Yes in Step B23).

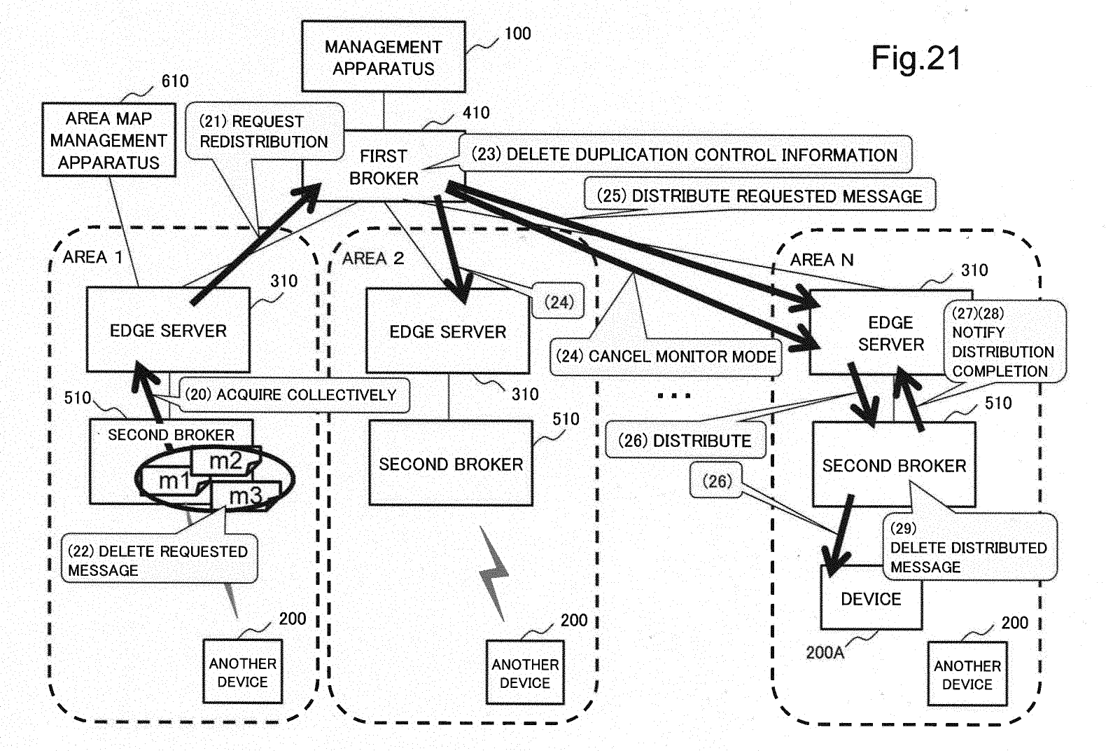

(19) Then, the request destination determination unit 312 in the edge server 310 in the area 1 determines the edge server 310 in the area N as a destination master server. Then, the request destination determination unit 312 determines the edge server 310 in the area N and edge servers 310 therearound as request destinations for redistribution. It is assumed that the neighboring edge servers 310 are edge servers 310 in an area N-2 and an area N-1 (Step B24, B25).
(20) Next, in FIG. 21, in order to request redistribution, the redistribution request unit 313 in the edge server 310 in the area 1 collectively acquires from the second broker 510 the messages m1 to m3 for the device 200A (Step S122 in FIG. 11 and Step C11 in FIG. 15).
(21) Next, the redistribution request unit 313 in the edge server 310 in the area 1 requests redistribution of each of the collectively acquired messages m1 to m3 to each edge server 310 in the areas N, N-1, and N-2 determined as the request destinations (Step C12). The request for redistribution is performed through redistribution topics in the first broker 410. Then, the redistribution request unit 313 notifies the second broker 510 of completion of the redistribution request (Step C13).
(22) In the second broker 510 notified of completion of the redistribution request, the distribution status management unit 512 deletes the messages m1 to m3 from the message management table (Step S112 in FIG. 11).
(23) Further, the message distribution unit 411 in the first broker 410 receiving the message of which redistribution is requested deletes the duplication control information related to the message m1 (Step S131 in FIG. 11 and Step C14 in FIG. 15).
(24) Further, the message distribution unit 411 in the first broker 410 distributes information instructing cancellation of the monitor mode to each edge server 310 to which the inquiry about a connection history of the device 200A being the destination of the message m1 has been made up to that point (Step C15).
(25) Further, the message distribution unit 411 in the first broker 410 distributes each of the requested messages m1 to m3 to each edge server 310 in the areas N, N-1, and N-2 (Step C16).
(26) Then, the message transmission-reception unit 311 in each edge server 310 in the areas N, N-1, and N-2 distributes each of the messages m1 to m3 to the device 200A through a second broker 510 in each area (Steps D11 and D12 in FIG. 16).
(27) Then, in the area N, distribution of the messages m1 to m3 to the device 200A succeeds. Then, the edge server 310 in the area N receives a redistribution completion notification from the second broker 510 (Step D13 and Yes in D15). Then, in the edge server 310 in the area N, the redistribution request unit 313 notifies the redistribution completion to each edge server 310 in the other areas N-1 and N-2 to which redistribution of the messages m1 to m3 has been requested similarly to the own edge server (Step D16).
(28) Then, in each edge server 310 in the areas N-1 and N-2, the redistribution request unit 313 notifies the second broker 510 in each area of cancellation of distribution of the messages m1 to m3 (Yes in Step D17 and D18).
(29) Further, in the second broker 510 in the area N, since distribution of the messages m1 to m3 is completed, the distribution status management unit 512 deletes the messages from the message management table. Further, in each second broker 510 in the areas N-2 and N-1, since distribution of the messages m1 to m3 is canceled, the distribution status management unit 512 deletes the messages from the message management table (Step D14).

The above concludes the description of the specific example.

Next, effects of the second example embodiment of the present invention will be described.

The communication system according to the second example embodiment of the present invention is able to more reliably distribute a message to a mobile device in publish/subscribe communication through a multistage broker configuration.

The reason will be described. The present example embodiment includes the following configuration in addition to the configuration similar to that according to the first example embodiment of the present invention. Specifically, by referring to area map information, the request destination determination unit in an edge server extracts edge servers located around the own edge server as candidates of a request destination. Then, the request destination determination unit inquires of another edge server being a candidate of the request destination about whether or not a connection history to the relevant device exists, and based on the inquiry result, estimates a destination server out of the candidates. Then, the request destination determination unit extracts an edge server located around the destination server as a candidate of a new request destination. Then, the request destination determination unit repeats making the inquiry described above to another edge server being a candidate of the request destination, and based on the inquiry result, estimating a destination server out of the candidates. Then, the request destination determination unit determines a destination master server being a destination server estimated at a point when a predetermined condition is satisfied and an edge server around the destination master server as request destinations for redistribution.

Thus, when a device expected to exist in an area distribution in which is handled by an edge server moves, the present example embodiment precisely estimates another edge server capable of distribution to the moving device, by repetition processing based on area map information. Consequently, the present example embodiment is also able to more reliably distribute to the moving device a message transmitted from the management apparatus at a delivery guarantee level guaranteeing arrival at the device.

Further, the present example embodiment is able to hold down a message volume saved in a second broker.

The reason will be described. When redistribution of a message determined to be unsuccessfully distributed is requested to another edge server, the distribution status management unit in the second broker according to the present example embodiment deletes the message from a memory.

Further, the present example embodiment is able to lighten a load on a second broker.

The reason will be described. The grouping unit in a second broker according to the present example embodiment collectively extracts messages for a device being the same as the destination of an unsuccessfully distributed message. Then, the distribution status management unit stops distribution of the extracted messages. Consequently, when distribution of a message to a device fails due to a move by the device, the present example embodiment is able to collectively stop distribution of messages to the device from the second broker. Consequently, a load on the second broker is lightened.

Further, the present example embodiment is able to hold down traffic between edge servers through the first broker.

The reason will be described. In order to determine a request destination for redistribution of an unsuccessfully distributed message, the request destination determination unit in an edge server according to the present example embodiment narrows candidates of an inquiry destination about a connection history by referring to area map information. Consequently, the number of other edge servers being inquiry targets can be held down. Additionally, the duplication control unit in the first broker controls an inquiry message about a connection history transmitted and received between edge servers in order to determine a request destination for redistribution of an unsuccessfully distributed message, in such a way as to avoid duplicate transmission to an edge server to which the inquiry message is already transmitted.

### Third Example Embodiment

Next, a third example embodiment of the present invention will be described in detail with reference to drawings. In each drawing referred to in the description of the present example embodiment, a configuration identical to and a step operating similarly to those according to the second example embodiment of the present invention are respectively given reference signs identical to those in the second example embodiment, and detailed description thereof in the present example embodiment is omitted.

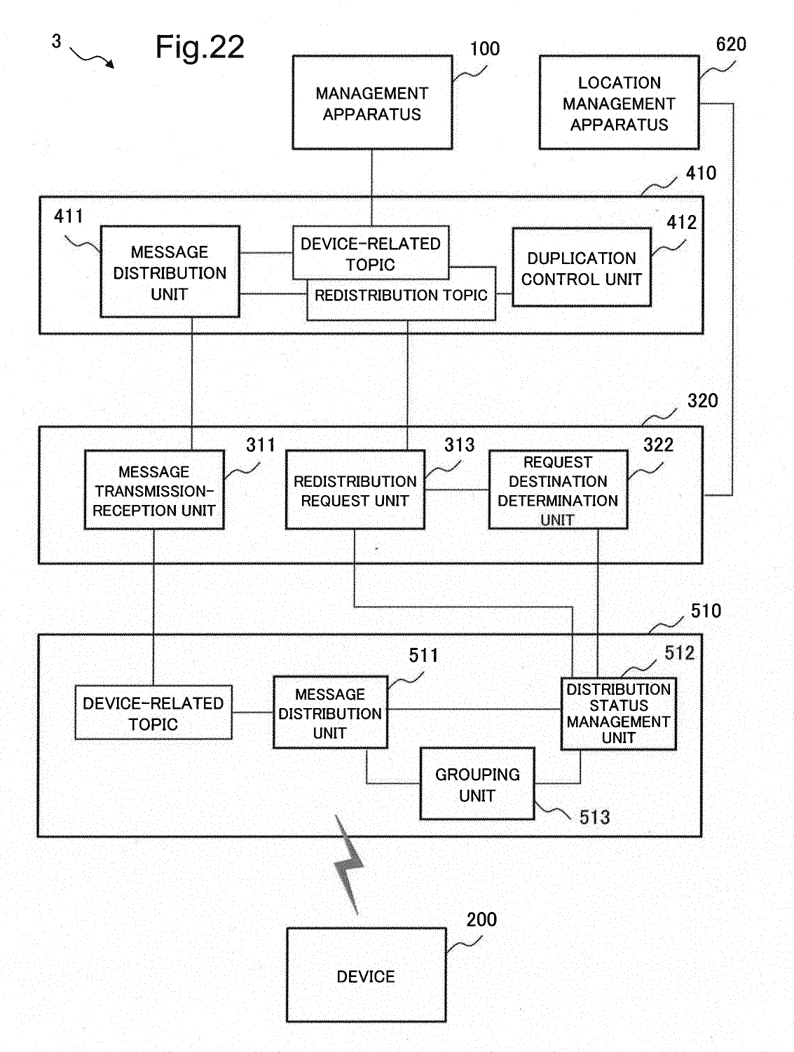

First, FIG. 22 illustrates a functional block configuration of a communication system 3 according to the present example embodiment. In FIG. 22, the communication system 3 differs from the notification system 2 according to the second example embodiment of the present invention in the following points. Specifically, the communication system 3 includes an edge server 320 in place of the edge server 310 and a location management apparatus 620 in place of the area map management apparatus 610. The location management apparatus 620 and the edge server 320 are communicably connected through a network.

Each apparatus constituting the communication system 3 may be configured with a hardware element similar to that according to the first example embodiment of the present invention described with reference to FIG. 2. Further, the location management apparatus 620 may be configured with an apparatus including a CPU, a memory, and a network interface. However, the hardware configuration of each apparatus constituting the communication system 3 is not limited to the aforementioned configuration.

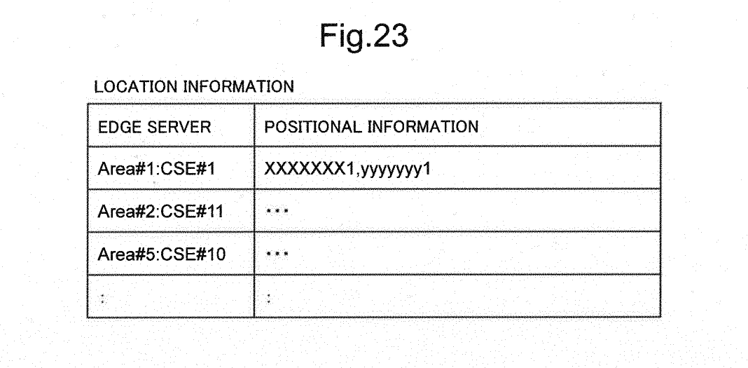

First, the location management apparatus 620 will be described. The location management apparatus 620 stores location information indicating a spatial position of an edge server 320. For example, FIG. 23 illustrates an example of the location information. In FIG. 23, the location information is information obtained by associating an ID identifying an edge server 320 with positional information thereof. The location information illustrated in FIG. 23 is an example, and a content and a form of location information are not limited.

Further, when receiving identification information of an edge server 320 being a reference, the location management apparatus 620 returns identification information of another edge server 320 extracted based on a distance from a position of the reference edge server 320. For example, the location management apparatus 620 may extract up to a predetermined number of other edge servers 320 in ascending order of distances from the position of the relevant edge server 320. Alternatively, the location management apparatus 620 may extract another edge server 320, a distance from the server to the position of the relevant edge server 320 being within a threshold value. The extraction criterion for another edge server 320 based on location information is not limited to the above.

Next, functional blocks in the edge server 320 will be described.

In FIG. 22, the edge server 320 differs from the edge server 310 according to the second example embodiment of the present invention in including a request destination determination unit 322 in place of the request destination determination unit 312.

The request destination determination unit 322 is configured almost similarly to the request destination determination unit 312 according to the second example embodiment of the present invention. However, details of the extraction processing of a candidate of a request destination differ.

Specifically, the request destination determination unit 322 acquires a candidate of an inquiry destination about a connection history of a device 200 being a destination of an unsuccessfully distributed message, by making an inquiry to the location management apparatus 620. In other words, in repetition processing for estimating a destination server, the request destination determination unit 322 transmits identification information of the own edge server or a destination server to the location management apparatus 620. Then, the request destination determination unit 322 may determine another edge server 320 indicated by identification information returned from the location management apparatus 620 as a candidate of the destination.

An operation of the thus configured communication system 3 will be described.

The operation of the communication system 3 is almost similar to the operation of the communication system 2 described with reference to FIGS. 11 to 16. However, the detailed operations in Steps B12 and B24 in FIG. 13 differ.

In Step B12, the request destination determination unit 322 transmits identification information of the destination server to the location management apparatus 620. Then, the request destination determination unit 322 acquires as a candidate of a request destination another edge server 320 indicated by identification information returned from the location management apparatus 620.

Further, in Step B24, the request destination determination unit 322 transmits identification information of the destination master server to the location management apparatus 620. Then, the request destination determination unit 322 specifies another edge server 320 indicated by identification information returned from the location management apparatus 620.

The above concludes the description of the operation of the communication system 3.

Next, effects of the third example embodiment of the present invention will be described.

The effects of the third example embodiment of the present invention are almost similar to the effects of the second example embodiment of the present invention.

However, the reason is slightly different. The request destination determination unit in an edge server according to the third example embodiment of the present invention determines a candidate of a request destination for redistribution of an unsuccessfully distributed message, based on location information indicating a spatial position of an edge server.

Accordingly, the present example embodiment is able to more precisely estimate an edge server capable of redistribution of a message unsuccessfully distributed due to a move by a device, based on location information, and more reliably execute redistribution of the message.

Further, the present example embodiment narrows destinations of an inquiry about a connection history made to another edge server in order to determine a request destination for redistribution of an unsuccessfully distributed message, based on location information, and therefore is able to hold down traffic between edge servers.

### Fourth Example Embodiment

Next, a fourth example embodiment of the present invention will be described in detail with reference to drawings. In each drawing referred to in the description of the present example embodiment, a configuration identical to and a step operating similarly to those according to the second example embodiment of the present invention are respectively given reference signs identical to those in the second example embodiment, and detailed description thereof in the present example embodiment is omitted.

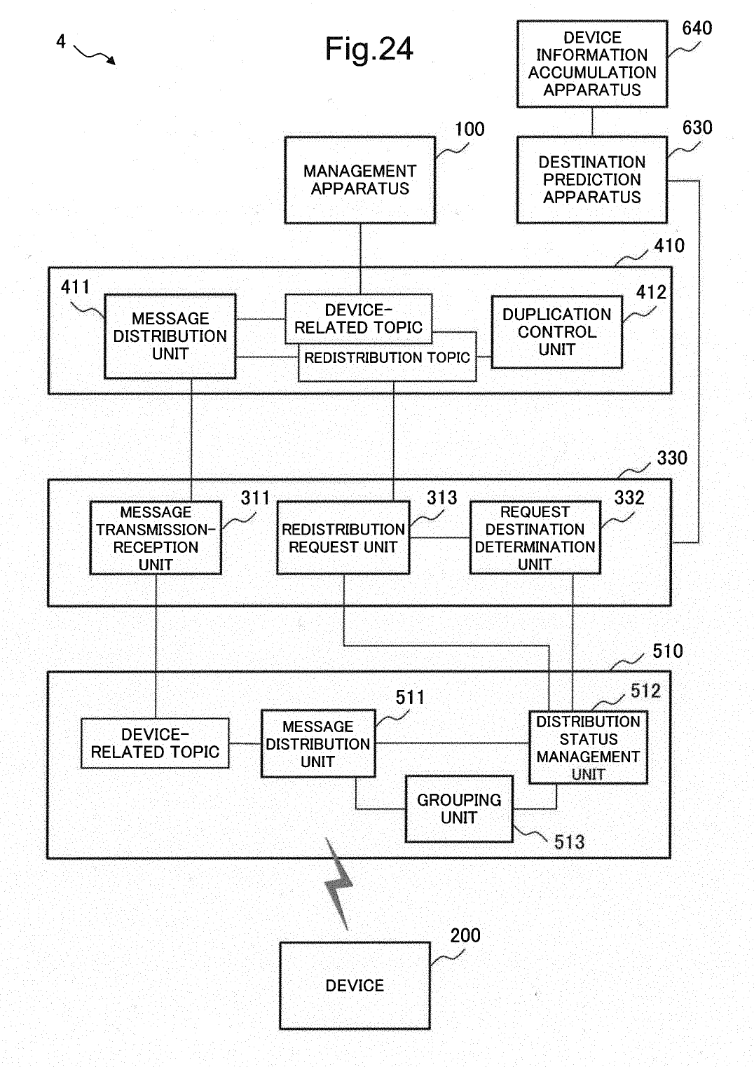

First, FIG. 24 illustrates a functional block configuration of a communication system 4 according to the present example embodiment. In FIG. 24, the communication system 4 differs from the notification system 2 according to the second example embodiment of the present invention in the following points. Specifically, the communication system 4 includes an edge server 330 in place of the edge server 310 and a destination prediction apparatus 630 in place of the area map management apparatus 610, and further includes a device information accumulation apparatus 640. The destination prediction apparatus 630 and the edge server 330 are communicably connected through a network. Further, the destination prediction apparatus 630 and the device information accumulation apparatus 640 are communicably connected through a network.

Each apparatus constituting the communication system 4 may be configured with a hardware element similar to that according to the first example embodiment of the present invention described with reference to FIG. 2. Further, each of the destination prediction apparatus 630 and the device information accumulation apparatus 640 may be configured with an apparatus including a CPU, a memory, and a network interface. However, the hardware configuration of each apparatus constituting the communication system 4 is not limited to the aforementioned configuration.

First, the device information accumulation apparatus 640 will be described. The device information accumulation apparatus 640 accumulates various kinds of information obtained from a device 200 in the communication system 4. For example, when various kinds of sensors are equipped on a device 200, information acquired from the sensors is accumulated into the device information accumulation apparatus 640, the information being associated with identification information of the device 200, identification information of the sensors, time information, and the like.

For example, device information may be values such as a temperature, humidity, and a weight of a product, the values being obtained from various kinds of sensors equipped on a device 200 as a product in a production line. Further, the device information may be values such as a body temperature, a body water content, and a momentum of a user, the values being obtained from various kinds of sensors equipped on a device 200 as wearable equipment worn by the user.

Next, the destination prediction apparatus 630 will be described. The destination prediction apparatus 630 predicts an edge server 330 handling distribution at a destination of a specified device 200, based on device information about the device 200, the information being accumulated in the device information accumulation apparatus 640.

For example, the destination prediction apparatus 630 may store location information about each edge server 330 and information indicating a characteristic of each device 200. In this case, the destination prediction apparatus 630 may predict a position of a destination of the relevant device 200 from device information about the device 200 obtained from the device information accumulation apparatus 640 and information indicating a characteristic of the device 200. Then, the destination prediction apparatus 630 may predict an edge server 330 handling distribution at the destination, based on the predicted position of the device 200 and the location information about the edge servers 330.

As a specific example, the destination prediction apparatus 630 may, for example, predict an area to which a product is conveyed in a production line, based on a weight of the product obtained from a device 200. Further, for example, the destination prediction apparatus 630 may predict that a user wearing wearable equipment moves to a vending machine area, based on a body temperature and a body water content obtained from the wearable equipment as a device 200, and weather information at that point in time. Additionally, the destination prediction apparatus 630 may apply various kinds of generally known technologies of predicting a destination of a device 200, based on accumulated device information.

Next, functional blocks of the edge server 330 will be described.

In FIG. 24, the edge server 330 differs from the edge server 310 according to the second example embodiment of the present invention in including a request destination determination unit 332 in place of the request destination determination unit 312.

The request destination determination unit 332 is configured almost similarly to the request destination determination unit 312 according to the second example embodiment of the present invention. However, details of the extraction processing of a candidate of a request destination differ.

Specifically, the request destination determination unit 332 acquires a candidate of an inquiry destination about a connection history of a device 200 being a destination of an unsuccessfully distributed message, by making an inquiry to the destination prediction apparatus 630. In other words, in repetition processing of estimating a destination server, by transmitting identification information of the own edge server or a destination server to the destination prediction apparatus 630, the request destination determination unit 332 may determine another edge server 330 indicated by returned identification information as a candidate of the destination.

An operation of the thus configured communication system 4 will be described.

The operation of the communication system 4 is almost similar to the operation of the communication system 2 described with reference to FIGS. 11 to 16. However, the detailed operations in Steps B12 and B24 in FIG. 13 differ.

In Step B 12, the request destination determination unit 332 transmits identification information of the destination server to the destination prediction apparatus 630. Then, the request destination determination unit 332 acquires another edge server 330 indicated by identification information returned from the destination prediction apparatus 630 as a candidate of a request destination.

Further, in Step B24, the request destination determination unit 332 transmits identification information of the destination master server to the destination prediction apparatus 630. Then, the request destination determination unit 332 specifies another edge server 330 indicated by identification information returned from the destination prediction apparatus 630.

The above concludes the description of the operation of the communication system 4.

Next, effects of the fourth example embodiment of the present invention will be described.

The effects of the fourth example embodiment of the present invention are almost similar to the effects of the second example embodiment of the present invention.

However, the reason is slightly different. The request destination determination unit in an edge server according to the fourth example embodiment of the present invention determines a candidate of a request destination for redistribution of an unsuccessfully distributed message, based on a prediction processing result of a destination of a device, the prediction being based on device information.

Accordingly, the present example embodiment is able to more precisely estimate an edge server capable of redistribution of a message unsuccessfully distributed due to a move by a device, based on a prediction processing result of a destination of the device, and more reliably execute redistribution of the message.

Further, the present example embodiment narrows destinations of an inquiry about a connection history made to another edge server in order to determine a request destination for redistribution of an unsuccessfully distributed message, based on a prediction processing result of a destination of a device, and therefore is able to hold down traffic between edge servers.

The communication system according to the present example embodiment may be configured to acquire device information from outside instead of including the device information accumulation apparatus. In that case, the destination prediction apparatus may predict a destination of a device, based on device information acquired from outside.

Further, the destination prediction apparatus according to the present example embodiment may predict a destination of a device, based on not only device information but also any information accumulable or acquirable in the communication system. In that case, the communication system may include an apparatus accumulating the information in place of the device information accumulation apparatus or acquire the information from outside.

Further, an example of the request destination determination unit in an edge server according to the aforementioned second to fourth example embodiments of the present invention extracting another edge server being a candidate of a request destination for redistribution, based on area map information, location information, or destination prediction processing, has been described. Without being limited to the above, the request destination determination unit may extract another edge server being a candidate of a request destination for redistribution, based on another type of information.

Further, an example of the duplication control unit in the first broker according to the aforementioned second to fourth example embodiments of the present invention using duplication control information exemplified in FIG. 7 has been described. However, a content and a form of the duplication control information are not limited. The duplication control information has only to be information for preventing duplicate transmission of an inquiry message to the same edge server.

Further, an example of a second broker according to the aforementioned second to fourth example embodiments of the present invention storing a message management table, a topic management table, and a distribution status table that are exemplified in FIGS. 8 to 10 has been described. However, a content and a form of information stored by each functional block in a second broker for managing distribution of a message and distribution status are not limited.

Further, an example of publish/subscribe communication being performed in accordance with MQTT, according to each of the aforementioned example embodiments of the present invention, has been described. Without being limited to the above, the present invention is applicable to a communication system performing publish/subscribe communication in accordance with another protocol.

Further, a configuration of the first broker directly connecting the management apparatus and an edge server, according to each of the aforementioned example embodiments of the present invention, has been described. Without being limited to the above, the management apparatus and the first broker, or the first broker and an edge server may be further connected through a multistage broker. Further, a configuration of a second broker directly connecting an edge server and a device has been described. Without being limited to the above, an edge server and a second broker, or a second broker and a device may be further connected through a multistage broker.

Further, an example of each functional block in each apparatus constituting the communication system being provided by a CPU executing a computer program stored in a memory, according to each of the aforementioned example embodiments of the present invention, has been mainly described. Without being limited to the above, a part, the whole, or a combination of each functional block may be provided by dedicated hardware.

Further, each functional block in each apparatus, according to each of the aforementioned example embodiments of the present invention, may be provided in such a way as to be distributed into a plurality of apparatuses.

Further, the operation of each apparatus described with reference to each flowchart, according to each of the aforementioned example embodiments of the present invention, may be stored in a storage apparatus (storage medium) in a computer apparatus as a computer program according to the present invention. Then, the CPU may read and execute such a computer program. Then, in such a case, the present invention is configured with a code of such a computer program or a storage medium.

Further, each of the aforementioned example embodiments may be implemented in an appropriately combined manner.

Further, the present invention may be implemented in various aspects without being limited to each of the aforementioned example embodiments.

Further, each of the aforementioned example embodiments may also be described in part or in whole as the following supplementary notes but is not limited thereto.

### (Supplementary Note 1)

An edge server including:

message transmission-reception unit configured to
receive, from a first broker connecting between a plurality of edge servers including an own edge server and a management apparatus by publish/subscribe communication, a message for a device to which distribution is handled by the own edge server, the message being transmitted by the management apparatus, or a message for a device to which redistribution is requested to the own edge server by another edge server and,
in order to distribute a received message to the device, transmitting the message to a second broker connecting between the own edge server and the device by publish/subscribe communication;

request destination determination unit configured to, when a distribution failure of the message to the device is notified from the second broker, determine another edge server being a request destination for redistribution of the message to the device; and

redistribution request unit configured to transmit the message to the first broker in order to request redistribution of the message to the device to another edge server being the request destination.

### (Supplementary Note 2)

The edge server according to Supplementary Note 1, wherein

the request destination determination unit

inquires of another edge server being a candidate of the request destination about whether or not a connection history to the device exists, through the first broker, and,

based on an inquiry result, determines an edge server being the request destination.

### (Supplementary Note 3)

The edge server according to Supplementary Note 1 or 2, wherein

the request destination determination unit

extracts an edge server located around the own edge server as a candidate of the request destination by referring to area map information indicating a positional relation between the edge servers and,

based on the candidate, determines an edge server being the request destination.

### (Supplementary Note 4)

The edge server according to Supplementary Note 1 or 2, wherein

the request destination determination unit

extracts a candidate of the request destination, based on a distance from the own edge server, by referring to location information indicating positional information of the edge server, and,

based on the candidate, determines an edge server being the request destination.

### (Supplementary Note 5)

The edge server according to Supplementary Note 1 or 2, wherein

the request destination determination unit

predicts a destination of the device, based on information acquired from the device,

extracts a candidate of the request destination, based on information of a predicted destination, and

determines an edge server being the request destination, based on the candidate.

### (Supplementary Note 6)

The edge server according to any one of Supplementary Notes 2 to 5, wherein

the request destination determination unit

estimates a destination edge server handling distribution to the device at a destination of the device, out of a candidate of the request destination,

repeats extracting a candidate of a new request destination, based on the destination edge server, and estimating a next destination edge server out of the candidate, and

determines an edge server being the request destination, based on a destination edge server estimated at a point of time when a predetermined condition is satisfied.

### (Supplementary Note 7)

The edge server according to any one of Supplementary Notes 1 to 6, wherein

the redistribution request unit collectively requests, to the request destination, redistribution of a message for a device being a destination of a message for which the distribution failure is detected in the second broker.

### (Supplementary Note 8)

The second broker according to any one of Supplementary Notes 1 to 7, including:

message distribution unit configured to distribute the message received from the edge server to the device; and

distribution status management unit configured to detect a distribution failure of the message to the device and notifying the edge server of the failure.

### (Supplementary Note 9)

The second broker according to Supplementary Note 8, further including:

grouping unit configured to collectively extract a message distributed to a device being a destination of a message for which the distribution failure is detected, wherein

the distribution status management unit stops distribution of a message extracted by the grouping unit.

### (Supplementary Note 10)

The second broker according to Supplementary Note 8 or 9, wherein

the distribution status management unit deletes, from a memory, a message of which redistribution is requested to the request destination.

### (Supplementary Note 11)

The first broker according to any one of Supplementary Notes 1 to 7, including:

message distribution unit configured to distribute, to the another edge server, the message of which the redistribution is requested to the another edge server by the edge server.

### (Supplementary Note 12)

The first broker according to Supplementary Note 11, further including:

duplication control unit configured to control the inquiry from the edge server according to Claim 2 in such a way as to avoid duplicate transmission of the inquiry to the identical another edge server.

### (Supplementary Note 13)

A communication system including:

the edge server according to any one of Supplementary Notes 1 to 7;

the second broker according to any one of Supplementary Notes 8 to 10;

the first broker according to Supplementary Note 11 or 12;

the management apparatus; and

the device.

### (Supplementary Note 14)

A method including:

receiving, from a first broker connecting between a plurality of edge servers including an own edge server and a management apparatus by publish/subscribe communication, a message for a device to which distribution is handled by the own edge server, the message being transmitted by the management apparatus, or a message for a device to which redistribution is requested to the own edge server by another edge server and,
in order to distribute a received message to the device, transmitting the message to a second broker connecting between the own edge server and the device by publish/subscribe communication;

when a distribution failure of the message to the device is notified from the second broker, determining another edge server being a request destination for redistribution of the message to the device; and

transmitting the message to the first broker in order to request redistribution of the message to the device to another edge server being the request destination.

### (Supplementary Note 15)

A storage medium storing a program that causes a computer to execute:

a step of receiving, from a first broker connecting between a plurality of edge servers including an own edge server and a management apparatus by publish/subscribe communication, a message for a device to which distribution is handled by the own edge server, the message being transmitted by the management apparatus, or a message for a device to which redistribution is requested to the own edge server by another edge server and,
in order to distribute a received message to the device, transmitting the message to a second broker connecting between the own edge server and the device by publish/subscribe communication;

a step of, when a distribution failure of the message to the device is notified from the second broker, determining another edge server being a request destination for redistribution of the message to the device; and

a step of transmitting the message to the first broker in order to request redistribution of the message to the device to another edge server being the request destination.

The present invention has been described above with the aforementioned example embodiments as exemplary examples. However, the present invention is not limited to the aforementioned example embodiments. In other words, various aspects that may be understood by a person skilled in the art may be applied to the present invention, within the scope thereof.

This application claims priority based on Japanese Patent Application No. 2016-028551 filed on Feb. 18, 2016, the disclosure of which is hereby incorporated by reference thereto in its entirety.

### INDUSTRIAL APPLICABILITY

For example, the present invention is applicable to a production management system at a plant. In that case, a device according to the present invention may be equipped on a container moving on a production line. Further, a management apparatus according to the present invention may control productions, based on information acquired from a sensor on the device, the information indicating an operating rate and an environment of the production line, and a state of a product. In such a production management system, the present invention is able to reliably distribute various kinds of messages from the management apparatus to the device equipped on the container.

Further, for example, the present invention is applicable to a crop management system. In that case, a device according to the present invention may be equipped on a basket used for transportation of a harvest. Alternatively, a device according to the present invention may be attached to a harvest itself as a tag. Further, a device according to the present invention may be equipped on a drone moving over a farm. Further, a management apparatus according to the present invention may manage a crop, based on a state of the crop and a state of the farm that are acquired from sensors on the devices. In such a crop management system, the present invention is able to reliably distribute various kinds of messages from the management apparatus to the devices attached to a basket and a crop, or the device equipped on a drone.

Further, for example, the present invention is applicable to a service providing system at an amusement park. In that case, a device according to the present invention may be applied as a wearable ticket and mobile equipment that are carried by a user. Further, by use of the device, a management apparatus according to the present invention may provide a user with information about a service. In such a service providing system, the present invention is able to reliably distribute a message such as recommended information to a moving user, based on information acquired from the device.

Further, for example, the present invention is applicable to a health care system at a sports gym. In that case, a device according to the present invention may be applied to sensor equipment worn by a member. Further, by use of the device, a management apparatus according to the present invention may provide a user with information about health care. In such a health care system, the present invention is able to reliably distribute a recommended menu and health care information to a moving user, based on physical information, a used menu, a momentum, a state of health (a heart rate, a body temperature, and a water content), and the like of the member that are acquired from the device.

Without being limited to the aforementioned industrial applicability, the present invention is applicable to various kinds of communication systems to which more reliable message distribution from a management apparatus to a mobile device is requested.

### REFERENCE SIGNS LIST

1, 2, 3, 4 Communication system
100 Management apparatus
200, 200A Device
300, 310, 320, 330 Edge server
301, 311 Message transmission-reception unit
302, 312, 322, 332 Request destination determination unit
303, 313 Redistribution request unit
400, 410 First broker
401, 411 Message distribution unit
412 Duplication control unit
500, 510 Second broker
501, 511 Message distribution unit
502, 512 Distribution status management unit
513 Grouping unit
610 Area map management apparatus
620 Location management apparatus
630 Destination prediction apparatus
640 Device information accumulation apparatus
1001, 2001, 3001, 4001, 5001 CPU
1002, 2002, 3002, 4002, 5002 Memory
1005, 2005, 3005, 4005, 5005 Network interface

What is claimed is:

1. An edge server comprising:
a memory storing instructions; and
one or more processors configured to execute the instructions to:
receive, from a first broker connecting between a plurality of edge servers including an own edge server and a management apparatus by publish/subscribe communication, a message for a device to which distribution is handled by the own edge server, the message being transmitted by the management apparatus, or a message for a device to which redistribution is requested to the own edge server by another edge server and,
in order to distribute the received message to the device, transmitting the message to a second broker connecting between the own edge server and the device by publish/subscribe communication;
when a distribution failure of the message to the device is notified from the second broker, determine another edge server being a request destination for redistribution of the message to the device; and
transmit the message to the first broker in order to request redistribution of the message to the device to another edge server being the request destination.

2. The edge server according to claim 1, wherein
the one or more processors are further configured to execute the instructions to:
inquire of another edge server being a candidate of the request destination about whether or not a connection history to the device exists, through the first broker, and,
based on an inquiry result, determines an edge server being the request destination.

3. The edge server according to claim 1, wherein
the one or more processors are further configured to execute the instructions to:
extract an edge server located around the own edge server as a candidate of the request destination by referring to area map information indicating a positional relation between the edge servers and,
based on the candidate, determines an edge server being the request destination.

4. The edge server according to claim 1, wherein
the one or more processors are further configured to execute the instructions to:
extract a candidate of the request destination, based on a distance from the own edge server, by referring to location information indicating positional information of the edge server, and,
based on the candidate, determines an edge server being the request destination.

5. The edge server according to claim 1, wherein
the one or more processors are further configured to execute the instructions to:
predict a destination of the device, based on information acquired from the device,
extract a candidate of the request destination, based on information of a predicted destination, and
determine an edge server being the request destination, based on the candidate.

6. The edge server according to claim 2, wherein
the one or more processors are further configured to execute the instructions to:
estimate a destination edge server handling distribution to the device at a destination of the device, out of a candidate of the request destination,
repeat extracting a candidate of a new request destination, based on the destination edge server, and estimating a next destination edge server out of the candidate, and
determine an edge server being the request destination, based on a destination edge server estimated at a point of time when a predetermined condition is satisfied.

7. The edge server according to claim 1, wherein
the one or more processors are further configured to execute the instructions to:
collectively request, to the request destination, redistribution of a message for a device being a destination of a message for which the distribution failure is detected in the second broker.

9-12. (canceled)

13. A communication system comprising:
the edge server according to claim 1;
the management apparatus; and
the device.

14. A method comprising:
receiving, from a first broker connecting between a plurality of edge servers including an own edge server and a management apparatus by publish/subscribe communication, a message for a device to which distribution is handled by the own edge server, the message being transmitted by the management apparatus, or a message for a device to which redistribution is requested to the own edge server by another edge server and,
in order to distribute the received message to the device, transmitting the message to a second broker connecting between the own edge server and the device by publish/subscribe communication;
when a distribution failure of the message to the device is notified from the second broker, determining another edge server being a request destination for redistribution of the message to the device; and
transmitting the message to the first broker in order to request redistribution of the message to the device to another edge server being the request destination.

15. A non-transitory computer readable storage medium storing a program that causes a computer to execute:
a process of receiving, from a first broker connecting between a plurality of edge servers including an own edge server and a management apparatus by publish/subscribe communication, a message for a device to which distribution is handled by the own edge server, the message being transmitted by the management apparatus, or a message for a device to which redistribution is requested to the own edge server by another edge server and,
in order to distribute the received message to the device, transmitting the message to a second broker connecting between the own edge server and the device by publish/subscribe communication;
a process of, when a distribution failure of the message to the device is notified from the second broker, determining another edge server being a request destination for redistribution of the message to the device; and
a process of transmitting the message to the first broker in order to request redistribution of the message to the device to another edge server being the request destination.
